(19) United States
(12) Patent Application Publication
(10) Pub. No.: US 2010/0300218 A1
(43) Pub. Date: Dec. 2, 2010

(54) DISPERSANT APPLICATION FOR CLEAN-UP OF RECIRCULATION PATHS OF A POWER PRODUCING FACILITY DURING START-UP

(75) Inventors: Keith Paul Fruzzetti, San Jose, CA (US); Charles Marks, McLean, VA (US)

Correspondence Address: TREGO, HINES & LADENHEIM, PLLC, 9300 HARRIS CORNERS PARKWAY, SUITE 210, CHARLOTTE, NC, 28269-3797, US

(73) Assignee: ELECTRIC POWER RESEARCH INSTITUTE, INC., Charlotte, NC (US)

(21) Appl. No.: 12/781,904

(22) Filed: May 18, 2010

Related U.S. Application Data
(60) Provisional application No. 61/183,252, filed on Jun. 2, 2009.

(51) Int. Cl. G01N 1/10; C02F 5/10; C02F 5/02

(52) U.S. Cl. 73/863.11; 210/696; 210/701; 210/704; 73/863.21

(57) ABSTRACT

A method for reducing corrosion product transport in a power producing facility. The method includes the steps of selecting a chemical dispersant adapted to reduce the deposition of corrosion products in the recirculation path, and using at least one chemical injector to inject the chemical dispersant into a fluid contained in the recirculation path during recirculation path cleanup to increase corrosion product removal.

This application claims the benefit of Provisional Application No. 61/183,252 filed on Jun. 2, 2009.

### BACKGROUND OF THE INVENTION

The present invention relates generally to a method of cleaning recirculation paths, and more particularly to a method of cleaning recirculation paths for a power producing facility, thereby reducing the inventory of corrosion products that can subsequently lead to steam generator fouling.

Steam generator (SG) fouling due to the accumulation of corrosion products from the secondary system remains a major problem in the nuclear industry. Such fouling causes heat-transfer losses, tube and internals corrosion degradation, level instabilities, and reductions in plant output. Many utilities report that a significant fraction of the corrosion product transport to the steam generator occurs during startup and devote substantial resources to limit or reduce fouling caused by corrosion products.

Currently, many power producing plants use methods such as top-of-tubesheet sludge lancing, chemical cleaning, advanced scale conditioning agent soaks, deposit minimization treatment, intertube lancing, upper bundle hydraulic cleaning, and bundle flushes to remove existing deposit material. Additionally, many nuclear plants perform a recirculation clean-up of the feedwater system during initial plant startup through a pathway that bypasses the steam generators. The purpose of such a clean-up process is to remove existing corrosion products from the systems that might otherwise later be transported to the steam generators.

Unfortunately, the prior art only addresses treatment of the feedwater entering the secondary side of the nuclear steam generator during operation. During operation the accumulation of metal-oxide deposits within a recirculating nuclear steam generator can be removed via blowdown. In a once-through nuclear steam generator (OTSG), metal-oxide corrosion product accumulation cannot be avoided since only a small percentage of the corrosion products are carried out of the OTSG with steam. Thus, the prior art is limited to recirculating steam generators. It is well-known by those knowledgeable in the art that sulfur species can accelerate PWR steam generator tube degradation. Therefore, the prior art has been limited to dispersants containing low concentrations of sulfur. Additionally, the prior art does not address fouling or corrosion product transport to a reactor of a BWR facility.

### BRIEF SUMMARY OF THE INVENTION

These and other shortcomings of the prior art are addressed by the present invention, which provides that additional corrosion products present in recirculation paths, such as feedwater and condensate systems, prior to start up be removed by adding a dispersant during recirculation periods. This would promote the retention of iron oxides in suspension until they can be eliminated from the system through drains, condensate polishers, filter elements, etc., and would reduce the inventory of corrosion products available for transport during operation.

Further, dispersants would provide a significant reduction in the time required to clean up the secondary system prior to power operation, a decrease in the inventory of deposits in the secondary cycle (that might otherwise be transported during power operation) and/or a significant decrease in the mass of corrosion product transported during operation early in the operating cycle (typical restart transients).

According to an aspect of the present invention, a method for reducing corrosion product transport in a power producing facility includes the steps of selecting a chemical dispersant adapted to reduce the deposition of corrosion products in the recirculation path; and using at least one chemical injector to inject the chemical dispersant into a fluid contained in the recirculation path during recirculation path cleanup to increase corrosion product removal.

According to another aspect of the present invention, a method of testing resuspension characteristics of a chemical dispersant includes the steps of providing a testing apparatus having a solution containment vessel, a drive system, and a shaft. The method further including the steps of attaching a substrate coated with deposit material to the shaft; immersing the coated substrate in a solution contained in the vessel; using the drive system to rotate the shaft and coated substrate at a predetermined velocity; and determining an amount of deposit material removed from the substrate.

According to another aspect of the present invention, a method of reentraining existing deposits in a recirculation path includes the steps of selecting a chemical dispersant adapted to suspend corrosion products in the recirculation path; using at least one chemical injector to inject a pre-determined amount of the chemical dispersant into a fluid contained in the recirculation path; and circulating the chemical dispersant in the recirculation path for a pre-determined amount of time to allow the chemical dispersant to mix with the fluid and suspend the corrosion products.

### BRIEF DESCRIPTION OF THE DRAWINGS

The subject matter that is regarded as the invention may be best understood by reference to the following description taken in conjunction with the accompanying drawing figures in which:

FIG. 1 is a diagram of dispersant use during long path recirculation;

FIG. 2 is a graph showing magnetite concentration v. % transmittance;

FIG. 3 is a graph showing Hematite concentration v. % transmittance;

FIG. 4 shows settling behavior of Magnetite with 100 ppm PAA (2 kD);

FIG. 5 shows settling behavior of Magnetite with 10,000 ppm PAA (2 kD);

FIG. 6 shows settling behavior of Hematite with 10,000 ppm PAA (2 kD);

FIG. 7 shows settling behavior of Magnetite with 100 ppm PAA (5 kD);

FIG. 8 shows settling behavior of Magnetite with 10,000 PAA (5 kD);

FIG. 9 shows settling behavior of Hematite with 10,000 ppm PAA (5 kD);

FIG. 10 shows settling behavior of Magnetite with 100 ppm PAA (high molecular weight);

FIG. 11 shows settling behavior of Magnetite with 10,000 ppm PAA (high molecular weight);

FIG. 12 shows settling behavior of Hematite with 10,000 ppm PAA (high molecular weight);

FIG. 13 shows settling behavior of Magnetite with 100 ppm PMAA;

FIG. 14 shows settling behavior of Magnetite with 10,000 ppm PMAA;

FIG. 15 shows settling behavior of Hematite with 10,000 ppm PAA;

FIG. 16 shows settling behavior of Magnetite with 100 ppm PMA:AA

FIG. 17 shows settling behavior of Magnetite with 10,000 ppm PMA:AA;

FIG. 18 shows settling behavior of Hematite with 10,000 ppm PMA:AA;

FIG. 19 shows settling behavior of Magnetite with 100 ppm PAAM;

FIG. 20 shows settling behavior of Magnetite with 10,000 ppm PAAM;

FIG. 21 shows settling behavior of Hematite with 10,000 ppm PAAM;

FIG. 22 shows settling behavior of Magnetite with 100 ppm PAA:SA;

FIG. 23 shows settling behavior of Magnetite with 10,000 ppm PAA:SA;

FIG. 24 shows settling behavior of Hematite with 10,000 ppm PAA:SA;

FIG. 25 shows settling behavior of Magnetite with 100 ppm PAA:SS:SA;

FIG. 26 shows settling behavior of Magnetite with 10,000 ppm PAA:SS:SA;

FIG. 27 shows settling behavior of Hematite with 10,000 ppm PAA:SS:SA;

FIG. 28 shows settling behavior of Magnetite with 100 ppm PAA:AMPS;

FIG. 29 shows settling behavior of Magnetite with 10,000 ppm PAA:AM PS;

FIG. 30 shows settling behavior of Hematite with 10,000 ppm PAA:AM PS;

FIG. 31 shows settling behavior of Magnetite with 100 ppm PAMPS;

FIG. 32 shows settling behavior of Magnetite with 10,000 ppm PAMPS;

FIG. 33 shows settling behavior of Hematite with 10,000 ppm PAMPS;

FIG. 34 shows settling behavior of Magneitite with 100 ppm PMA:SS;

FIG. 35 shows settling behavior of Magnetite with 10,000 ppm PMA:SS;

FIG. 36 shows settling behavior of Hematite with 10,000 ppm PMA:SS;

FIG. 37 shows the effects of dispersant candidates (10,000 ppm) on 10,000 ppm Fe₃O₄ (Magnetite) solution;

FIG. 38 shows dispersant candidate (10,000 ppm) screening tests—extended duration;

FIG. 39 shows the effects of dispersant candidates (100 ppm) on 10,000 ppm Fe₃O₄ (Magnetite) solution;

FIG. 40 shows dispersant candidate (100 ppm) screening tests—extended duration;

FIG. 41 shows the effects of dispersant candidates (10,000 ppm) on 10,000 ppm Fe₂O₃ (Hematite) solution;

FIG. 42 shows dispersant candidate (10,000 ppm) screening tests—extended duration;

FIG. 43 shows a resuspension test apparatus according to an embodiment of the invention;

FIG. 44 shows iron content of test solutions at 1 ppm dispersant for magnetite;

FIG. 45 shows iron content of test solutions at 100 ppm dispersant for magnetite;

FIG. 46 shows iron content of test solutions at 1 ppm dispersant for hematite; and

FIG. 47 shows iron content of test solutions at 100 ppm dispersant for hematite.

### DETAILED DESCRIPTION OF THE INVENTION

While the invention is being discussed in relation to PWRs and long path recirculation, it should be appreciated that the invention is not limited to long path recirculation and PWRs and may be used in other power producing facilities (such as a BWR) and with other recirculation paths (i.e., short recirculation path, steam and drain systems). PWRs and long path recirculation are used in this discussion for clarity and as examples only.

Dispersant application in nuclear power plants is currently only envisioned as an on-line application, during operation, to the feedwater entering the secondary side of a nuclear steam generator for the purpose of minimizing the accumulation of metal-oxide deposits within the nuclear steam generator, via blowdown removal, during the continuing operation of the steam generator.

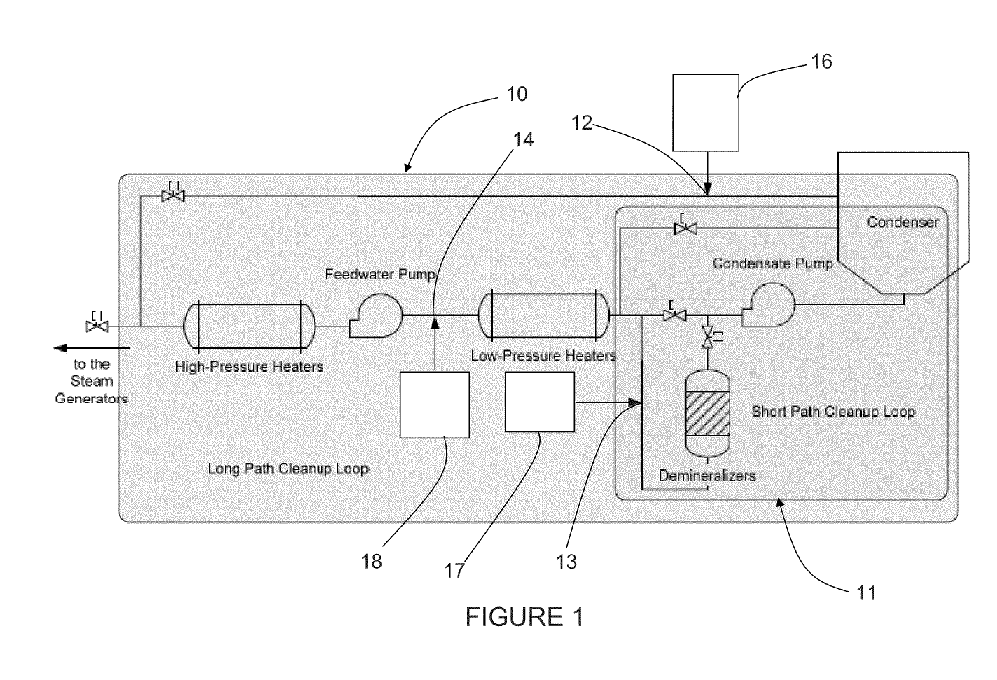

In power producing facilities, long path recirculation is used to remove corrosion products (primarily iron oxides and/or oxyhydroxides) from the feedwater and condensate systems prior to power production. This reduces the mass of corrosion products transported to the steam generator where corrosion products can deposit, exacerbating tube corrosion and reducing thermal efficiency. Long and short path recirculation loops for a power producing facility are shown generically in FIG. 1 at reference numerals 10 and 11.

With regards to long path recirculation, the invention uses a process of injecting a dispersant in the long path recirculation clean-up process as proposed for a feed train of a plant's secondary system outside of the nuclear steam generator, where the treatment water containing the dispersant would have no contact or limited contact (valve leakage) with the nuclear steam generator. The invention further encompasses clean-up of a plant's secondary system outside of the nuclear steam generator, and thus removal of metal-oxides from the system before they can even enter the steam generator. In addition, the invention is applicable to plants with recirculating steam generators, plants with once-through steam generators (i.e, independent of steam generator type), and BWRs with reactors.

As described herein, the use of dispersants during long path recirculation increases the efficiency of corrosion product removal, either reducing the mass ultimately transported to the steam generator or decreasing the time required for recirculation cleanup prior to power production. Dispersant injection locations are shown generically in FIG. 1 at reference numerals 12-14. Injection locations would be based on unit-specific designs; thus, a plant specific review should be performed prior to injection of a dispersant.

As shown, multiple locations may be used for injection. For example, one location may be just downstream of the purification equipment so that the entire system is exposed to the chemical. However, alternate locations may be used to provide significant cleanup benefits.

In general, the inventive process involves the injection of a chemical, using chemical injectors 16-18 (such as metering pumps), specifically a polymeric dispersant such as, but not limited to, poly acrylic acid (PAA), into the feedwater/condensate system during a recirculation path cleanup. The injectors 16-18 may be existing injectors or new injectors installed for injection of the dispersant. The process includes the injection of the chemical (which may occur on a one-time or continuous basis); recirculation of the system (which may be started before injection); and cleanup of the system (using existing equipment).

The selection of a specific chemical is a non-trivial matter, involving evaluation of efficacy as well as system compatibility. The rate and timing of chemical injection may be tailored to the individual unit considering various factors such as the estimated corrosion product loading, existing feedwater/condensate system configuration, and outage/startup schedule.

The dispersant functions by effectively increasing the diameter of the corrosion product particles (i.e., reducing their effective density), reducing the tendency of these particles to settle and facilitating re-entrainment of deposited material. These effects combine to increase the fraction of corrosion product that circulates with the water in the system relative to the fraction which is retained on surfaces. The circulating corrosion product particles may be easily removed from the system by the existing equipment (for example, ion exchange resin beds, filters, etc.) or through system dumps. Because the chemical increases the fraction maintained in suspension, its use increases the fraction which may be removed during cleanup, resulting in either removal of a greater mass, faster removal of the same mass, or both. In some cases, cleanup times are related to outage schedules. Specifically, the window during which recirculation can occur is fixed. At other units, cleanup is continued until a predefined criterion (iron concentration, filter color, etc.) is reached. Chemical addition to increase suspended corrosion product concentrations would be beneficial in both of these cases.

Dispersant efficacy is defined in part by the polymer's ability to decrease particle settling velocity. Particle settling velocity was determined from the spectrophotometry data obtained from tests in which the solution transmittance was measured at various time intervals. The settling velocity of a particle in a given fluid is a function of its density and diameter, as well as the density and viscosity of the fluid. Two experiments without dispersant were therefore performed to characterize the settling behavior of magnetite and hematite particles and to develop a conversion between the reported transmittance and the concentration of the deposit material in solution. This was done by measuring the percentage of light transmitted through the solution at various time intervals and correlating these measurements to the theoretically calculated concentration of deposit material after the same time period.

The concentration of deposit material in solution at each time period is determined as follows. The suspended particles (magnetite or hematite) can be modeled as approximately spherical particles settling in a low turbulence (low Reynold's number) environment. Under these conditions, the settling rate is described by Stoke's Theorem:

$$\frac{g {{D}_{p}}^{2} \times ( {p}_{p} - {p}_{f} )}{18 μ} = {v}_{t}$$

where Dₚ is the particle diameter; pₚ and p_{f} are the densities of the particle and fluid, respectively; μ is the viscosity of the fluid; g is the gravitational constant; and vₜ is the settling velocity.

A particle size distribution was previously determined (by laser particle size analysis) for magnetite and hematite deposit materials. Particle size measurements were taken before and after a brief sonication period to ensure that the measurement was not affected by agglomerates. From the geometry of the spectrophotometer chamber, the settling velocity of the largest particle remaining in solution can be determined for any time interval.

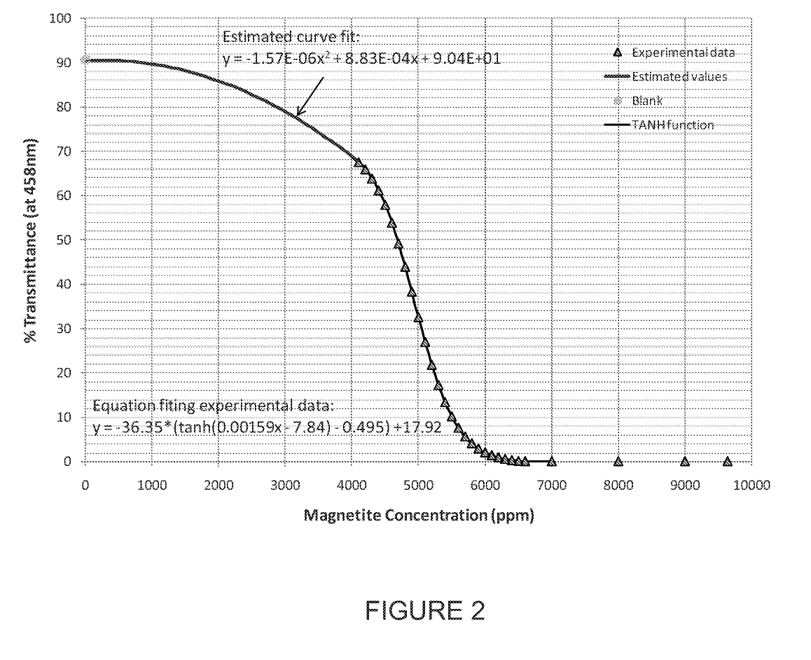

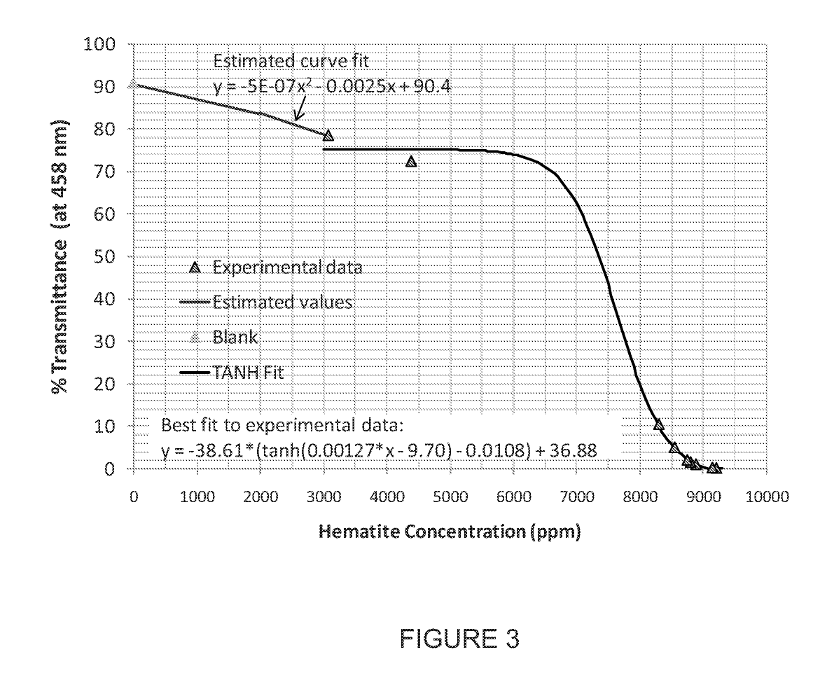

The transmittance measurement at each time point was plotted against the concentration of the relevant control, determined from the size distribution data and Stokes' model for particle settling at low Reynold's numbers. A relationship between transmittance and concentration was then found by fitting the resulting curve to a tanh function. The point of zero transmittance predicted by this model was ˜6500 ppm. These regions correspond to transmittances between 67% and 90.7% (the transmittance of deionized water) for magnetite, and from 78% to 90.7% for hematite. In both regions, the curve can be described by a second-order polynomial. The plots of the transmittance-concentration relationships for magnetite and hematite are shown in FIGS. 2 and 3, respectively.

The objective of dispersant addition is to decrease the settling velocity, which results in an apparent change particle diameter and density. Effective particle size S is used to describe this apparent particle diameter and density and is defined as:

$$S = {D}_{p , e}^{2} ( {p}_{p , e} - {p}_{f} ) = \frac{18 {v}_{t} μ}{g}$$

where the e subscript indicates the “effective” or apparent value. A parameter describing the difference in the apparent and actual particle sizes, which are proportional to settling velocity, can then be generated for each time point by comparing the “effective” particle size with the particle size corresponding to the observed concentration per the following equation:

$$\% Change = \frac{C - S}{C}$$

where C is the calculated particle size based on the observed transmittance in the absence of dispersant, and Pₚ and P_{f} are the known densities of the deposit material and deionized water. The parameter C is given by the following equation:

C=D²_{p,calc}(p_{p,magnetite}−p_{f})

The “% Change” therefore refers to the percentage decrease in settling rate that is observed in the presence of a dispersant. This settling rate was used to solve for “S”. “C” was then determined using the settling velocity of the control experiment at the current transmittance reading. The values for C and S were then used to determine the relative change in settling velocity (% Change).

Some general observations made during testing include:
At 100 ppm dispersant (a dispersant:magnetite ratio of 1:100), the effectiveness of polymeric dispersants in dispersing magnetite typically increases with increasing particle size.
At 10,000 ppm dispersant, the settling rate of larger magnetite particles was accelerated by high molecular weight dispersants. High molecular weight dispersants may promote particle agglomeration at these concentrations.
For low molecular weight dispersants, the dispersant was on the same order of effectiveness at both concentrations/dispersant-iron ratios.
All candidate dispersants except PAAM promoted the retention of hematite in the solution.
Sulfur-containing dispersants did not perform significantly better than the strictly acrylic/methacrylic/maleic acid copolymers. Thus, sulfur-containing dispersants should be used in a limiting fashion due to materials compatibility concerns. This would eliminate much of the risk associated with potential dispersant ingress into the steam generator during this application (through leaking isolation valves, human error, etc.).

Example dispersants for use in recirculation paths and the changes in the effective particle diameter (and therefore settling velocity) in the presence of a polymeric dispersant are summarized in Table 1.

TABLE 1

| | | Improvement in Performance | | |
|---|---|---|---|---|
| | | | | Hematite |
| | Molecular | | | 10,000 ppm |
| | Weight | Magnetite | | Dispersant |
| Dispersant | (Daltons) | 100 ppm Dispersant (1:100) | 10,000 ppm Dispersant (1:1) | (1:1) |
| PAA | 2000 | ~17% (<3 μm); ~40% (larger particles) | ~18% | ~50% |
| | 5000 | ~10-20% | 0-50% (Improvement | ~50-70% |
| | | | decreases with increasing | |
| | | | size) | |
| | N.P. | ~18-50% (Improvement increases with | Acceleration in settling rate for | ~100% |
| | | increasing size) | particle diameters >5 μm | |
| PMAA | 6500 | ~19-50% (Improvement increases with | ~22-56% | ~60% |
| | | increasing size) | | |
| PMA:AA | 3000 | ~17% (<1 μm); ~30% (larger particles) | ~20% (except particles <1 μm) | ~70% |
| PAAM | 200,000 | ~25-50% (<2.5 μm) | Acceleration in settling rate for | No |
| | | | particles >4.5 μm. No | significant |
| | | | significant change for small | change |
| | | | particles | |
| PAA:SA | <15,000 | ~25-50% (Improvement increases with | <20%; Decrease for large | 30-60% |
| | | increasing size) | (>12 μm) particles | |
| PAA:SS:SA | N.P. | ~40% (>5 μm); improvement | ~40% (3-5 μm); improvement | 40-80% |
| | | decreases with decreasing size | decreases with decreasing | |
| | | | size (<3 μm) | |
| PAA:AMPS | 5000 | 18-42% (Improvement increases with | ~30% | 40-60%; |
| | | increasing size) | | 80% (~2 μm) |
| PAMPS | 800,000 | No significant affect | Large acceleration in settling | 70-90% |
| | | | rate with increasing particle | |
| | | | size (>3.5 μm) | |
| PMA:SS | 20,000 | ~20-40% (Improvement increases with | ~20-40% (Improvement | ~30-68% |
| | | increasing size) | increases with increasing | |
| | | | size) | |

The Polyacrylic Acid (PAA) effectively decreased the settling velocity of magnetite particles ˜1-10 μm in size by ˜20-50%. This polymer was also the most effective at dispersing hematite, which constitutes a major portion of feedwater system deposits.

Three PAA candidates were evaluated. All three PAA candidates evaluated demonstrated similar levels of efficacy in dispersing both magnetite and hematite. In particular, a low molecular weight polymer (2000 Daltons), a low-moderate molecular weight polymer (5000 Daltons), and a high molecular weight polymer were evaluated.

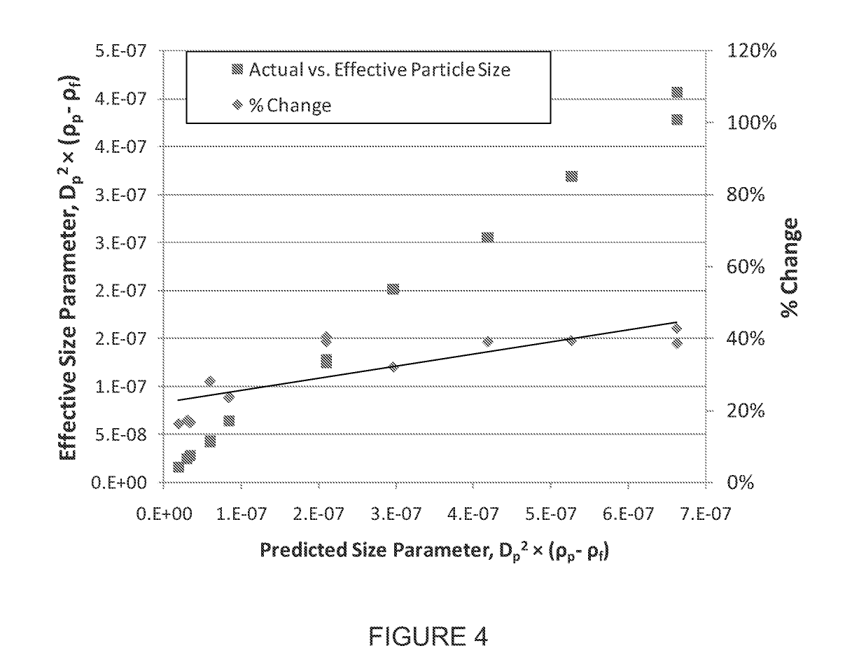

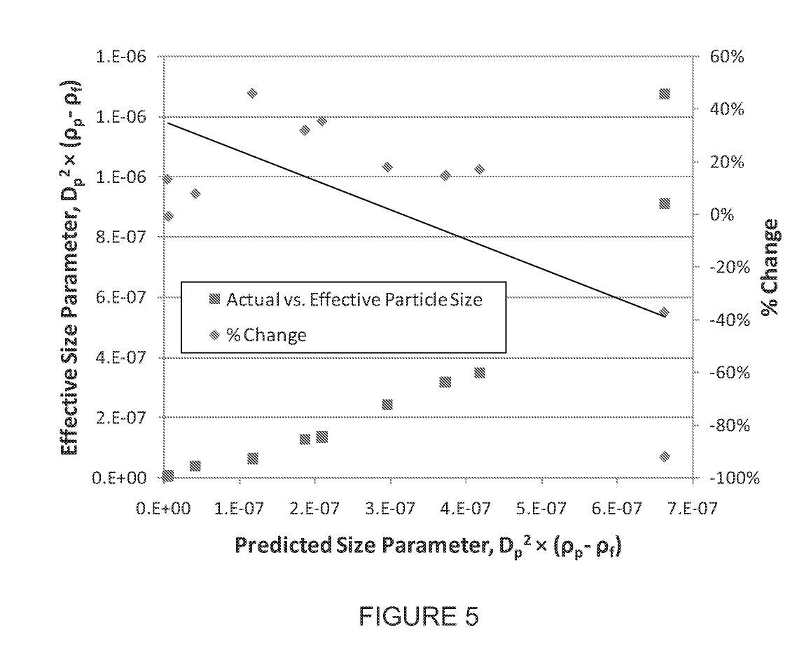

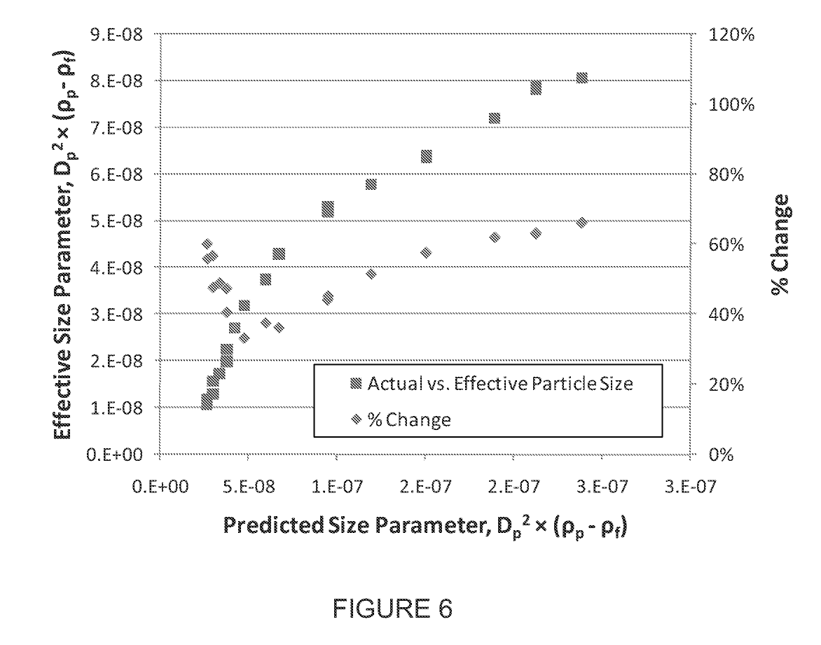

The low molecular weight polymer performed moderately well at dispersing both large and small particles. The dispersant was more effective at dispersing magnetite at the lower (1:100) dispersant:iron ratio. Specifically, the following results were obtained:
At 100 ppm dispersant: The settling time was increased by ˜40% for large particles and ˜17% for smaller particles. The results of this test are shown in FIG. 4.
At 10,000 ppm dispersant: The settling time increased by ˜18%, with the exception of two outlier points at large particle sizes. The results of this test are shown in FIG. 5.
Hematite dispersion: The dispersant increased the settling time of hematite by ˜50% across a broad range of particle sizes. The results of this test are shown in FIG. 6.

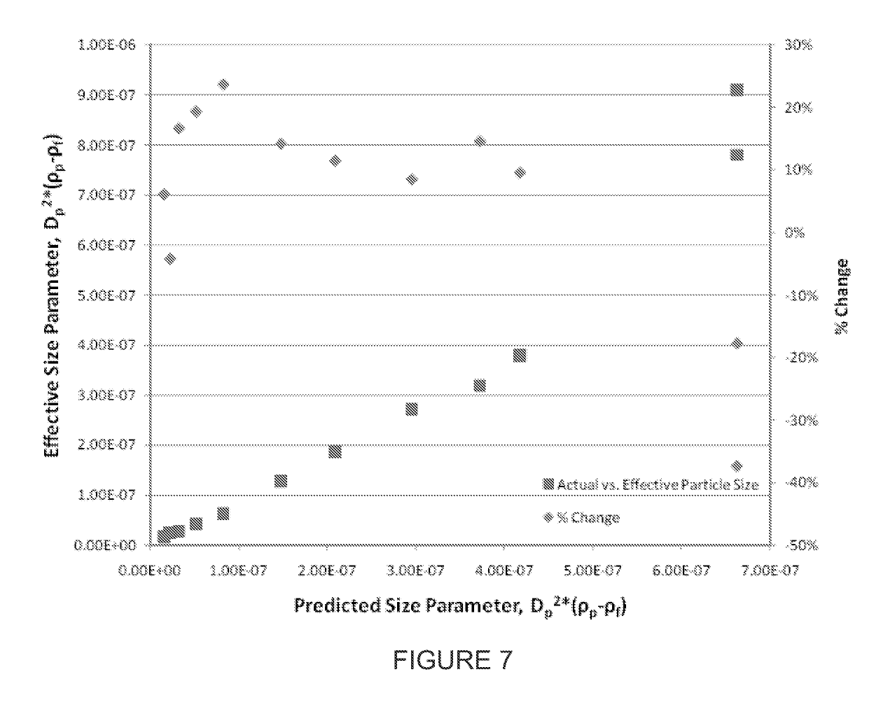

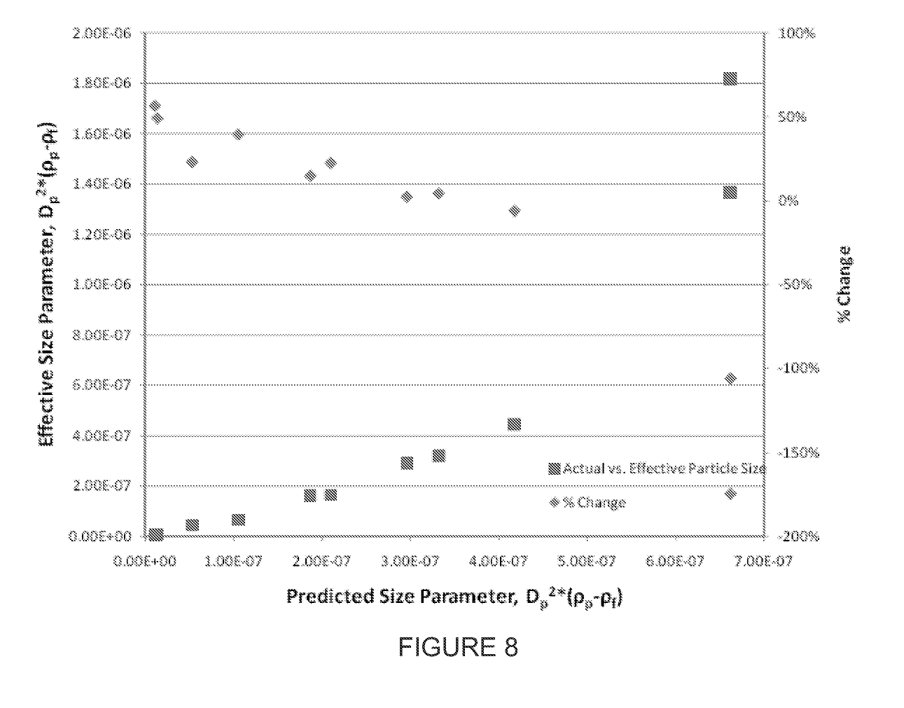

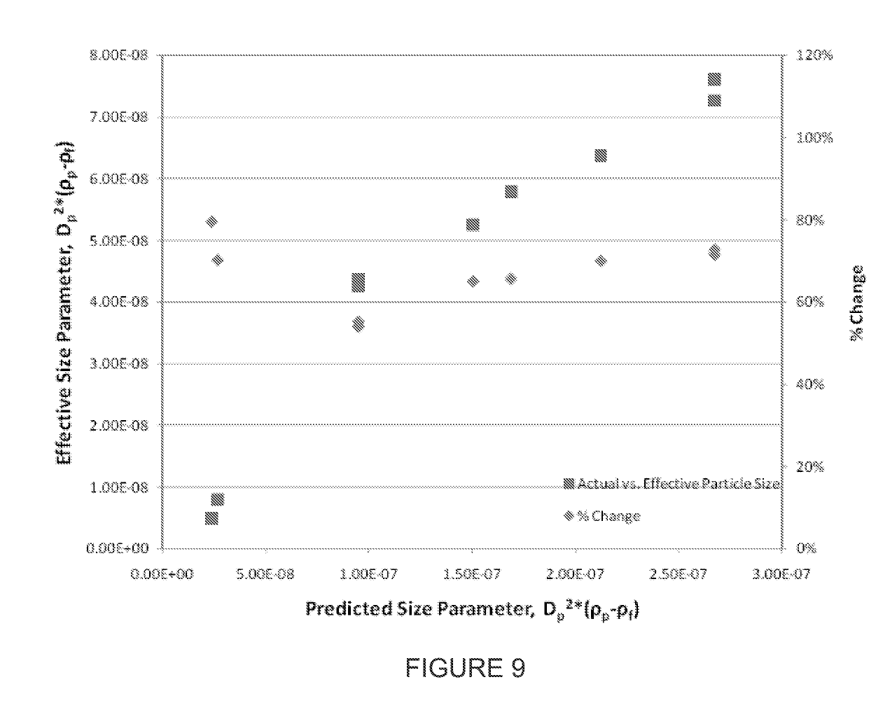

The low-moderate molecular weight polymer resulted in small improvements in an intermediate particle size range, but showed anomalous increases in settling rate at the extremes. Overall, this polymer appears to be less effective than the low molecular weight polymer. The following observations were made from these tests:
At 100 ppm: The dispersant increased settling time by ˜10-20% for some particle sizes, but showed substantial decreases in performance at other points. The results of this test are shown in FIG. 7.
At 10,000 ppm: The dispersant increased settling time by up to 50% for small particles, but had little effect on intermediate particle sizes. The settling time of the largest particles was greatly decreased. The results of this test are shown in FIG. 8.
Hematite dispersion: The low-moderate molecular weight polymer increased hematite settling time by 50-70%. The results of this test are shown in FIG. 9.

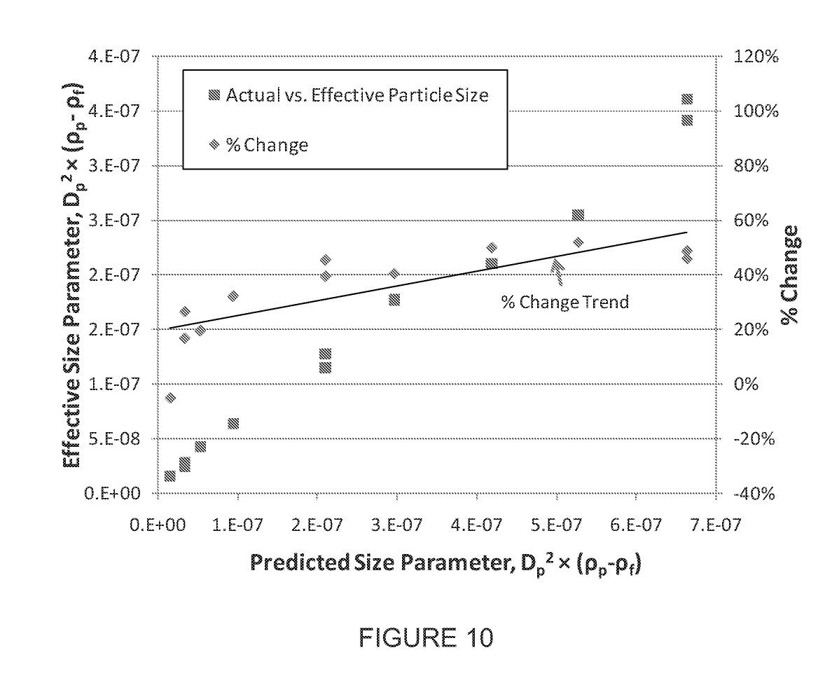

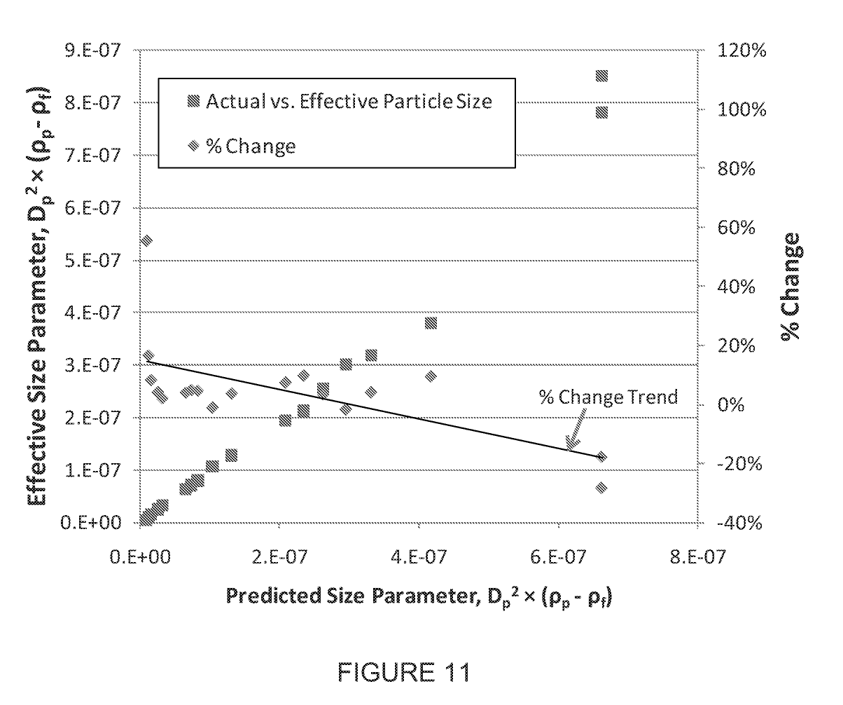

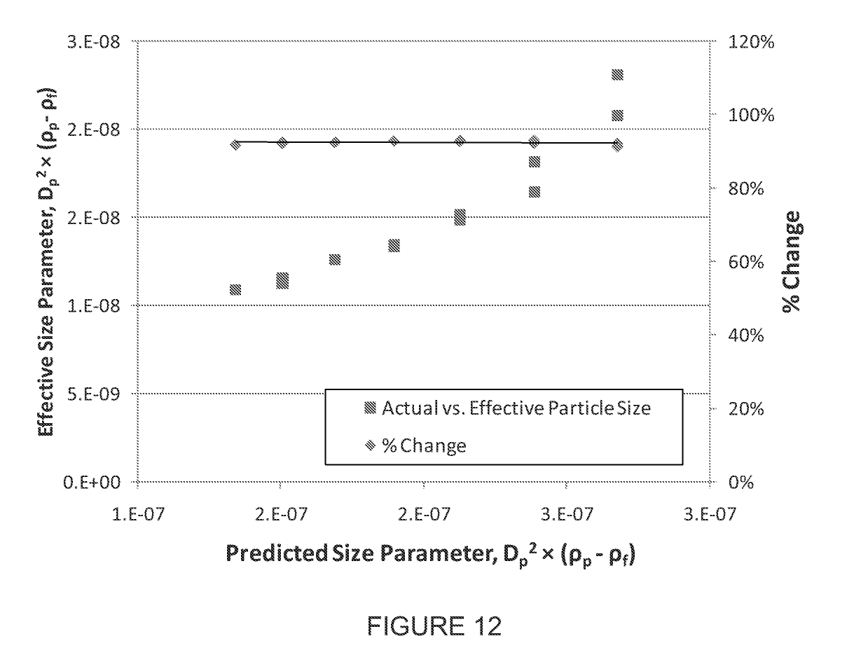

The high molecular weight polymer performed well at a low concentrations (100 ppm), but was less effective at 10,000 ppm.
At 100 ppm: The settling time increased by 18% to 50% with increasing particle size. The results of this test are plotted in FIG. 10.
At 10,000 ppm: The settling time increased slightly (up to about 20%) for smaller particles. However, for larger particles, the settling time decreased by about 20%. The results of this test are plotted in FIG. 11.
Hematite dispersion: The dispersant consistently increased the settling time by almost 100% across the particle distribution tested. The results of this test are plotted in FIG. 12.

The generic Polymethacrylic Acid (PMAA) polymer similarly demonstrated high efficacy at a concentration of 100 ppm. Unlike many of the dispersant candidates, it did not increase the rate of settling or promote agglomeration; PMAA was equally effective at a high concentration (10,000 ppm). The polymer was moderately effective at dispersing hematite, decreasing the settling velocity by ˜60%.

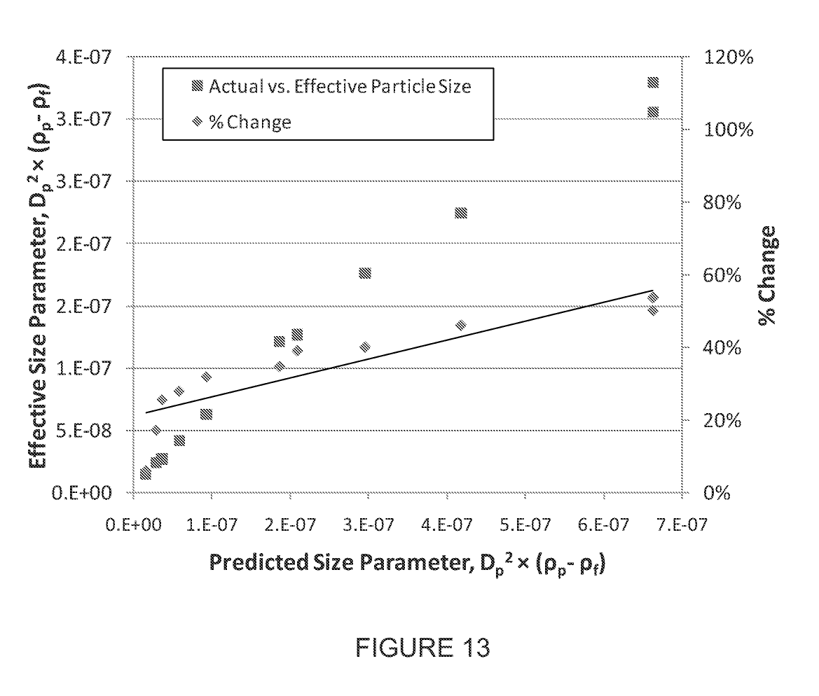

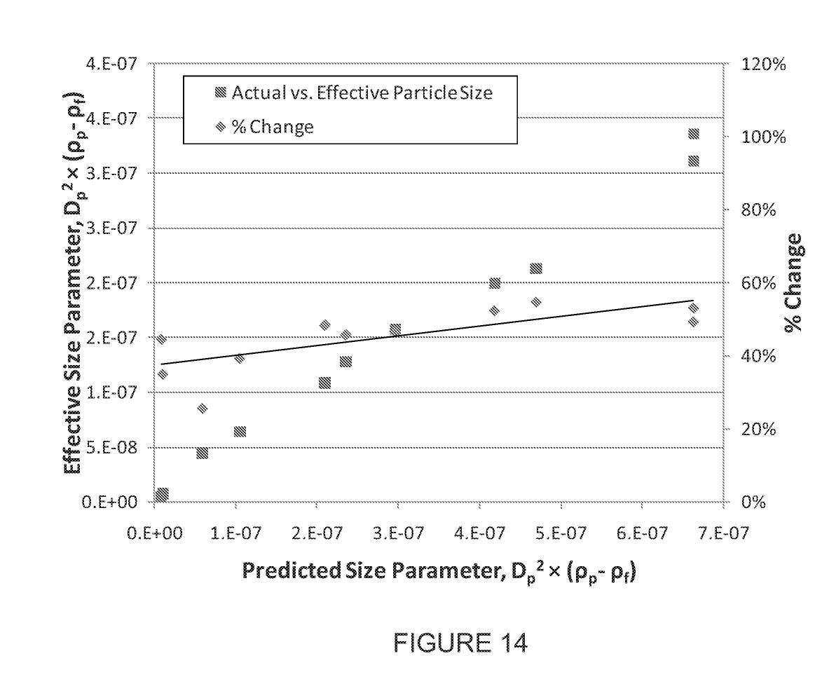

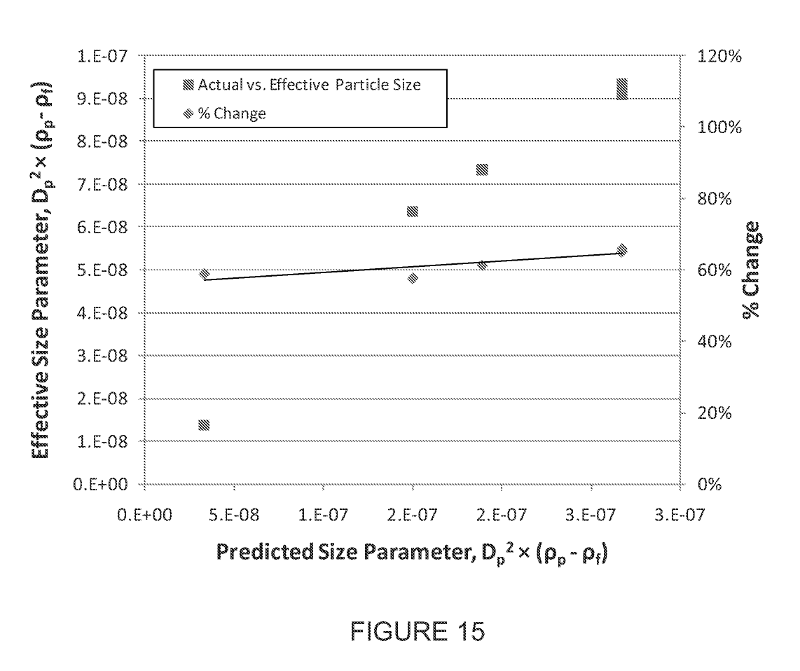

PMAA has been tested for boiler applications with moderate levels of efficacy. The PMAA used during this test program had a molecular weight of ˜6500 Daltons. The following observations were made.
At 100 ppm: The settling time increased by 19 to 50% with increasing particle size. The results of this test are plotted in FIG. 13.
At 10,000 ppm: The settling time increased by 22 to 56%. A weak correlation was observed between the improvement in settling rate and the particle size. The results of this test are shown in FIG. 14.
Hematite dispersion: Although few data points were available, the settling time increased by ˜60% for all particle sizes. The results of this test are shown in FIG. 15.

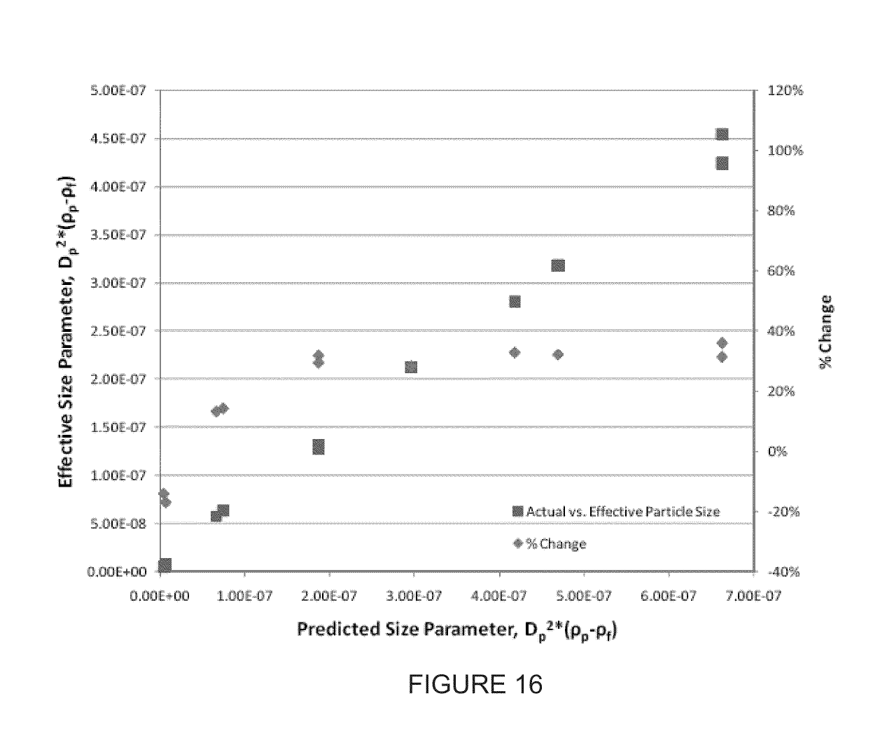

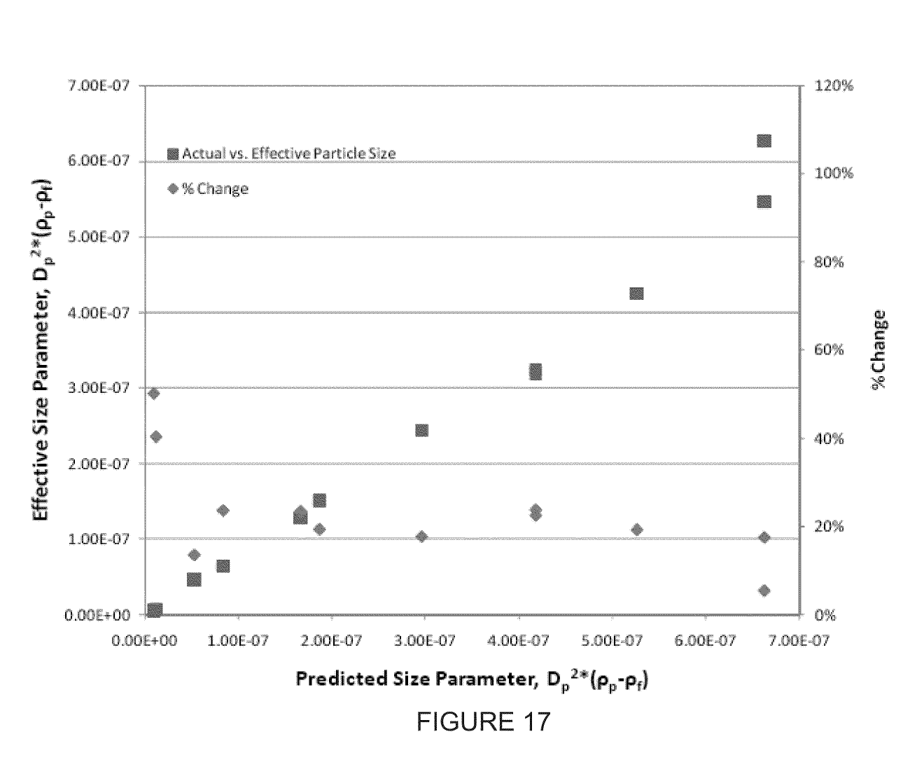

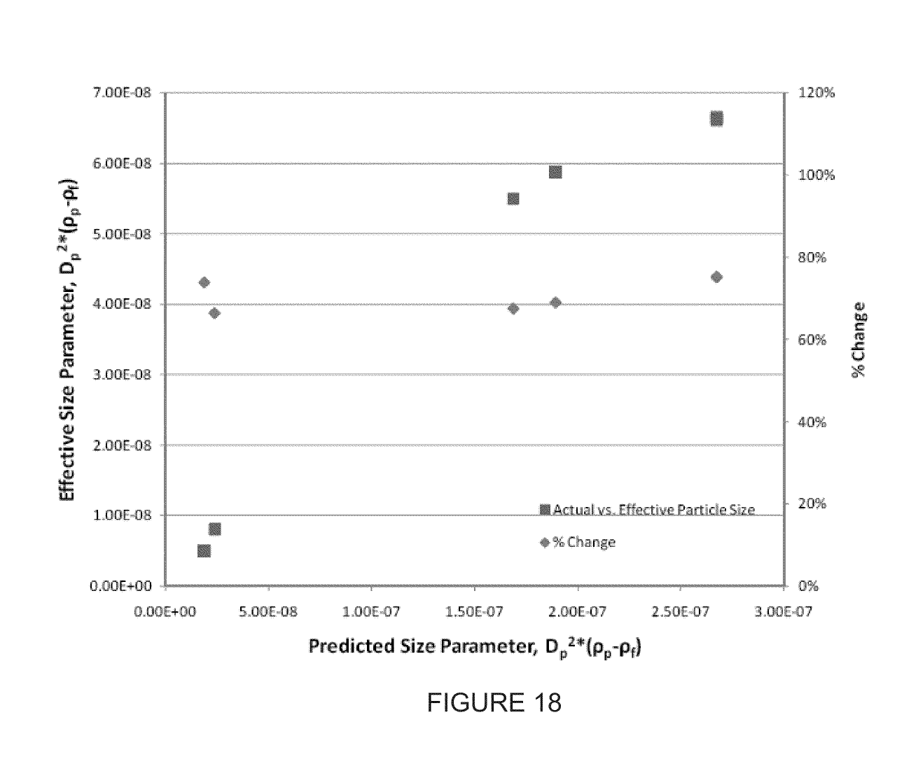

Other polymers were also evaluated. Poly(acrylic acid:maleic acid) (PMA:AA) had a molecular weight of ˜3000 Daltons and had the following characteristics:
At 100 ppm: The presence of the dispersant increased the settling time by ˜30% for moderate to large particle sizes, but decreased the settling time of ˜1 μm particles by almost 17%. The results of this test are shown in FIG. 16.
At 10,000 ppm: The settling time was increased by ˜20% with the exception of the smallest particles (˜1 μm), which demonstrated an extended settling time. The results of this test are shown in FIG. 17.
Hematite dispersion: A ˜70% increase in settling time was observed at all data points. The results of this test are shown in FIG. 18.

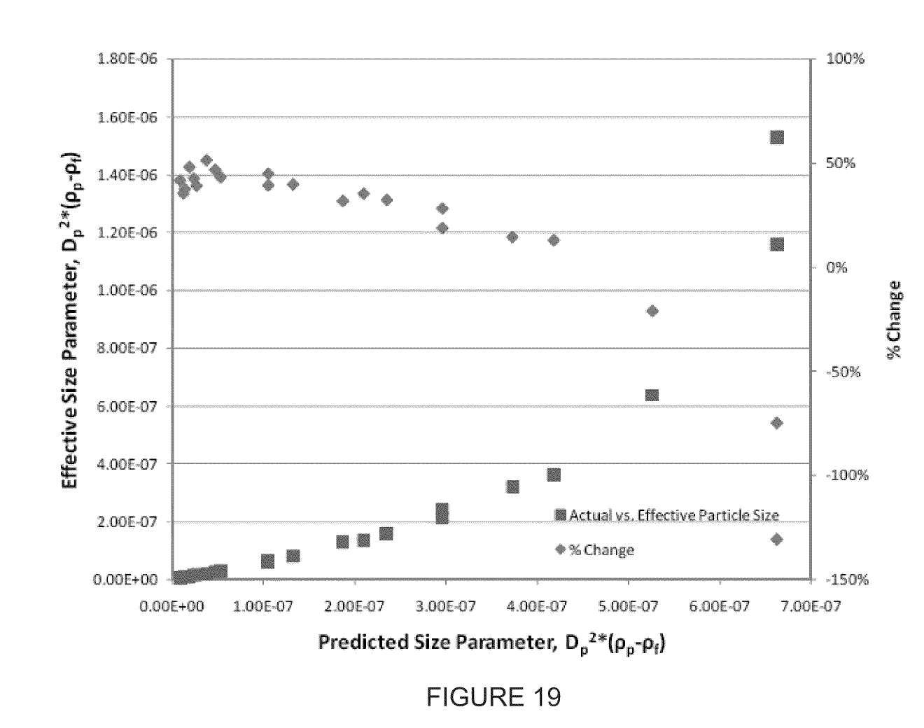

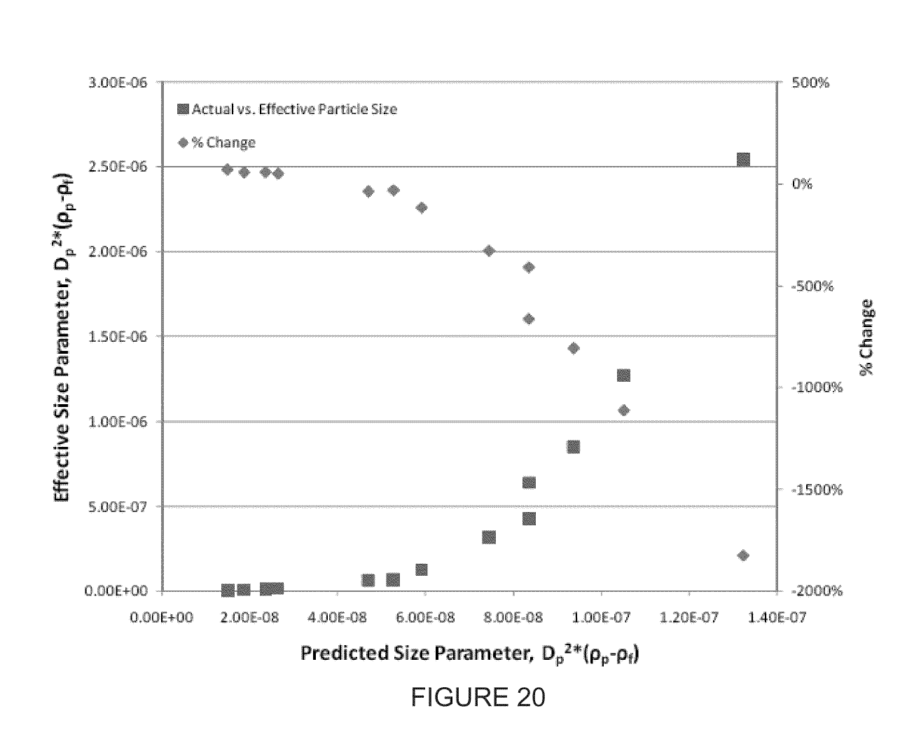

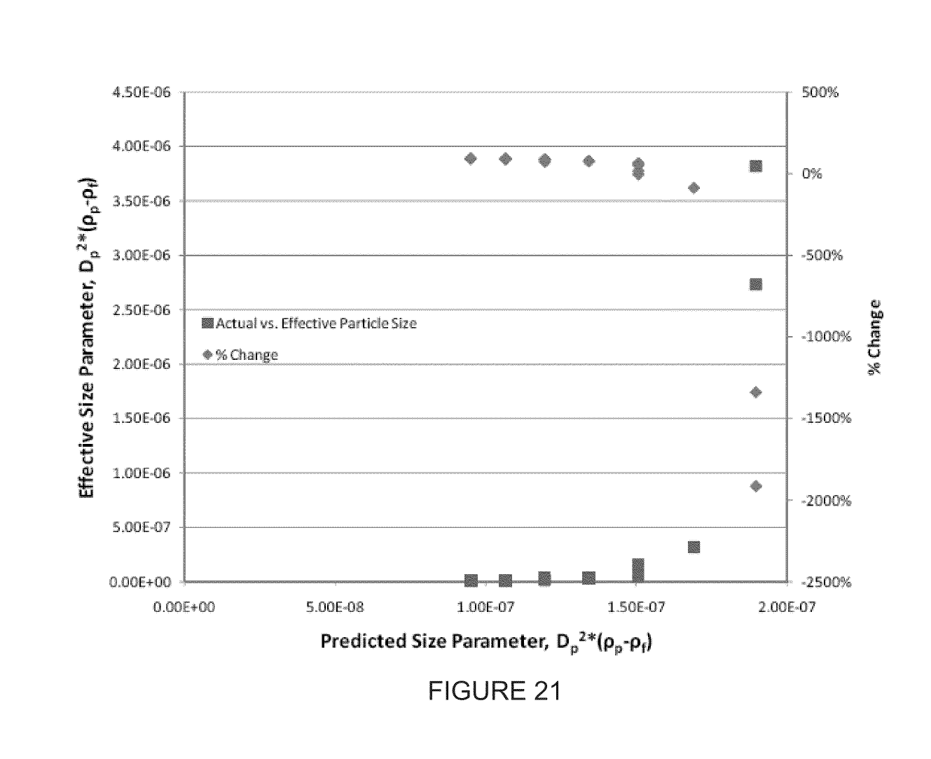

The Poly(acrylic acid:acrylamide) (PAAM) copolymer had an average molecular weight of ˜200,000 Daltons, making it significantly larger than the majority of the candidates. PAAM was the only dispersant tested that did not effectively disperse hematite.
At 100 ppm: The dispersant increased the settling time of small particles (diameter <2.5 μm) by 25-50%, but substantially decreased the settling time of particles greater than 10 μm in diameter. The results of this test are shown in FIG. 19.
At 10,000 ppm: Large increases in settling rate were observed in particles with diameters >4.5 μm. Little change in settling rate was observed for smaller particles. The results of this test are shown in FIG. 20.
Hematite dispersion: No significant change in the settling behavior of hematite was observed in the presence of 10,000 ppm PAAM. The results of this test are shown in FIG. 21.

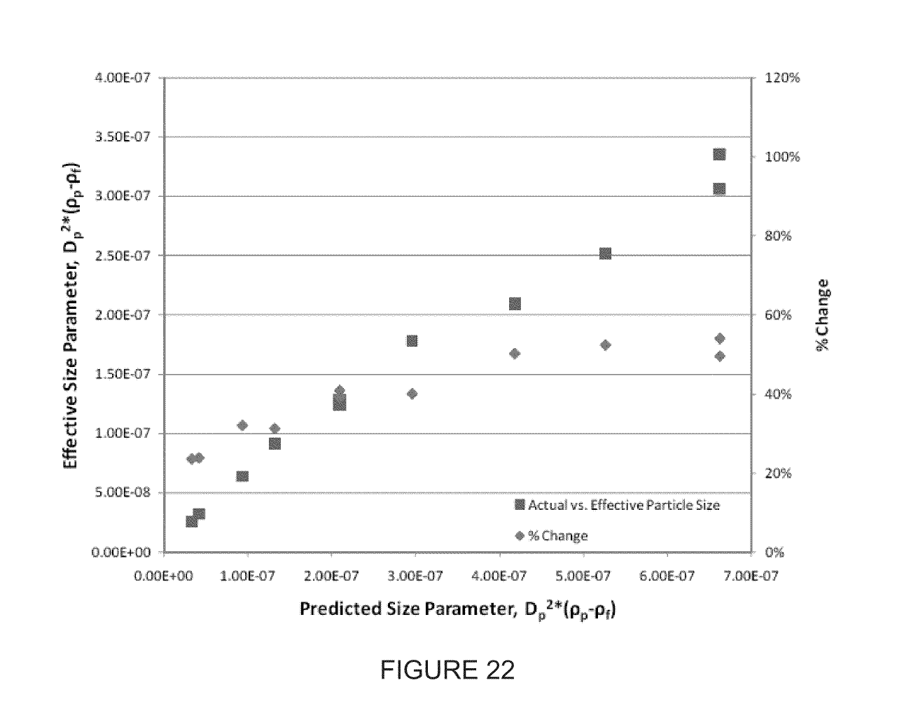

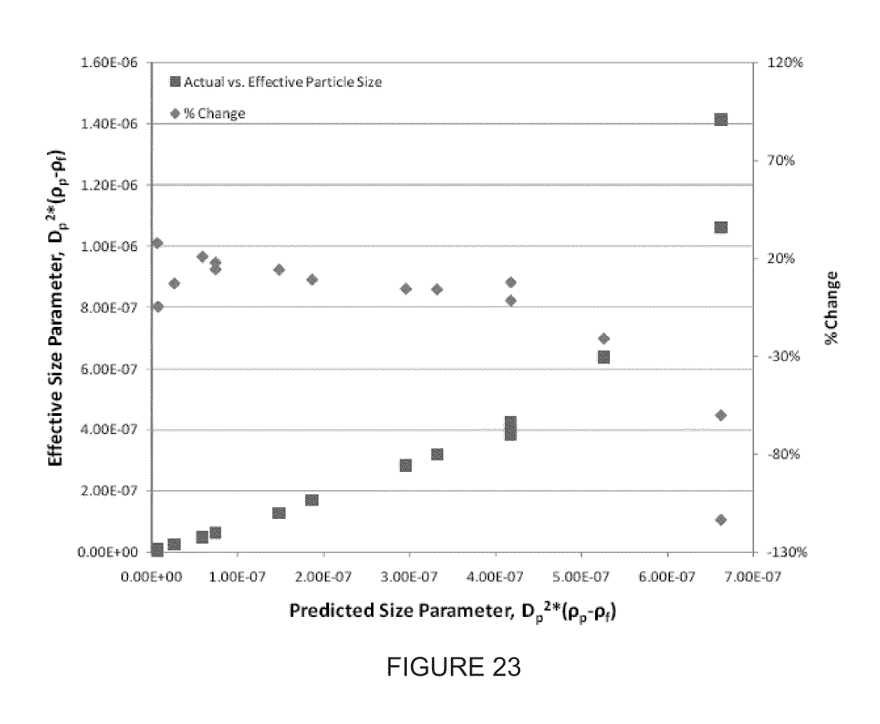

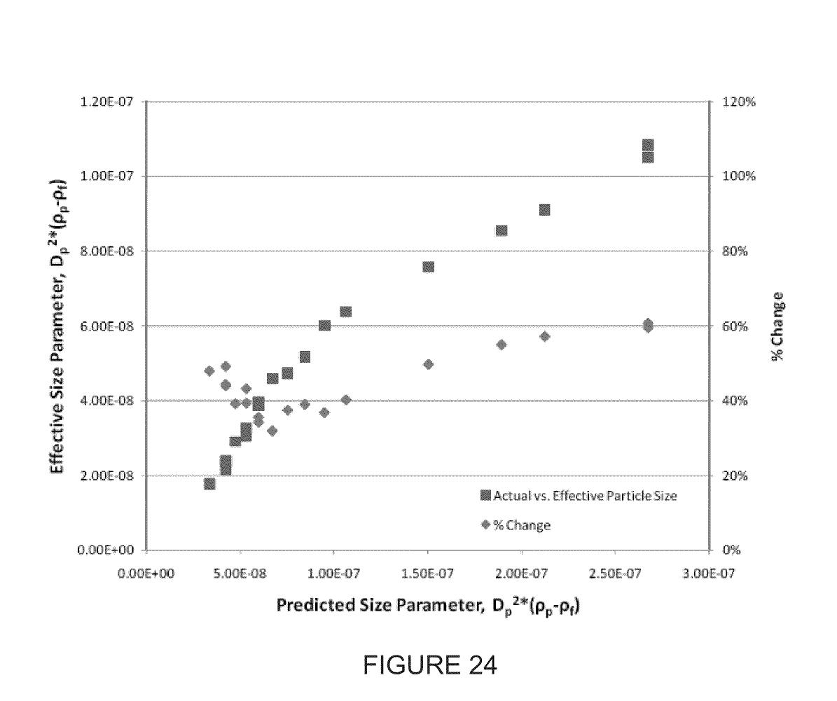

The poly(sulfonic acid:acrylic acid) (PAA:SA) copolymer had a molecular weight of <15,000 Daltons. The following observations were made.
At 100 ppm: A 20-50% improvement in settling time was observed. The increase in settling rate was larger for larger particles (˜12 μm) and lower for smaller particles (2-3 μm). The results of this test are shown in FIG. 22.
At 10,000 ppm: A small increase in settling time (<20%) was observed for most particle sizes. The settling time decreased for larger (˜12 μm) particles. The results of this test are shown in FIG. 23.
Hematite dispersion: A 30-60% increase in settling time was observed. The results of this test are shown in FIG. 24.

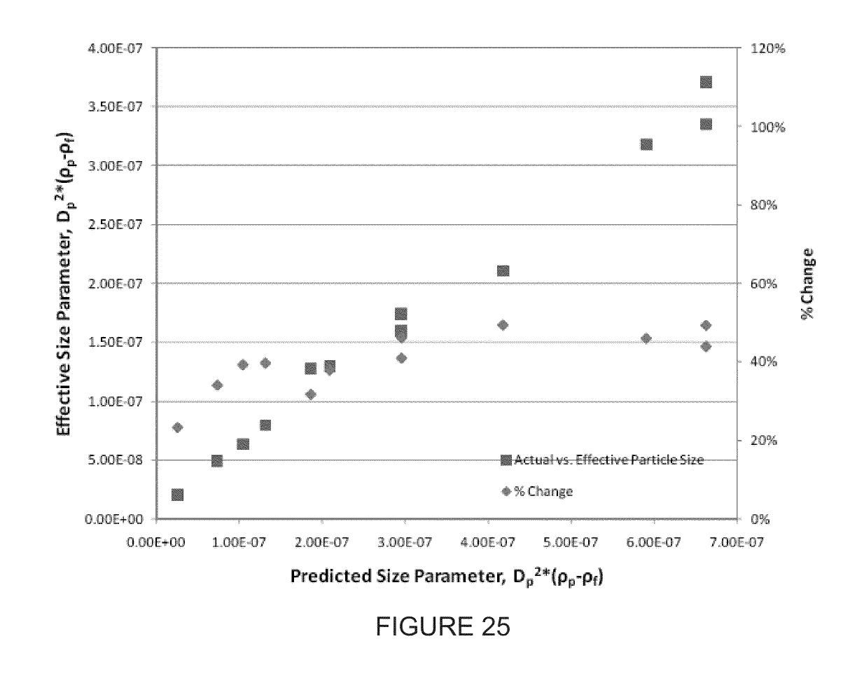

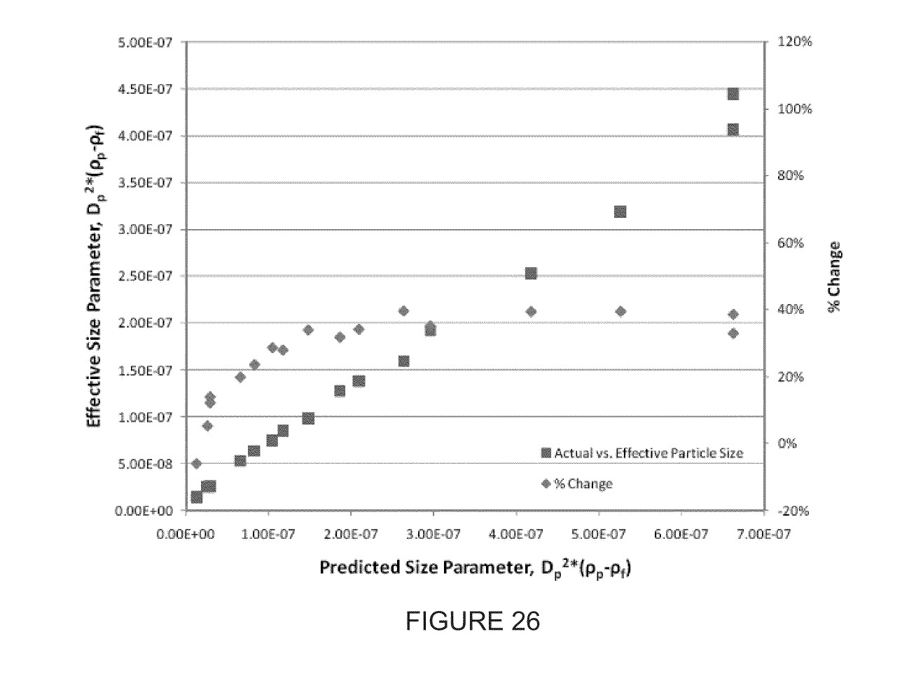

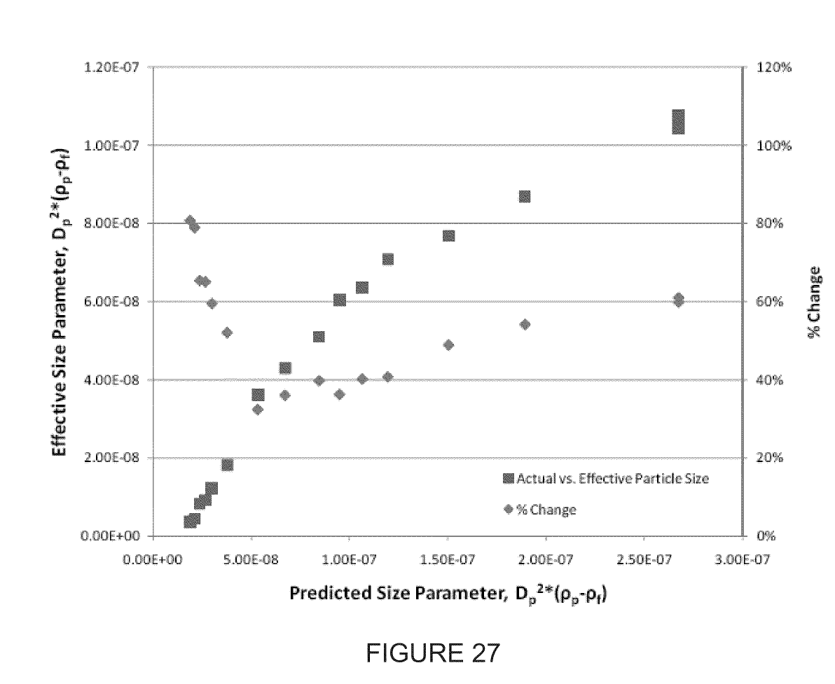

The Poly(acrylic acid:sulfonic acid:sulfonated styrene) (PAA:SS:SA) polymer had the following characteristics.
At 100 ppm: The settling time of magnetite increased by ˜40% for particles with diameters >5 μm. For smaller particles, a smaller increase in settling time was observed. The results of this test are shown in FIG. 25.
At 10,000 ppm: The settling time increased by ˜40% for particles 3-5 μm in diameter. Below 3 μm, the change in settling time decreased with decreasing particle size. The results of this test are shown in FIG. 26.
Hematite dispersion: A 40-80% improvement in settling time was observed. The results of this test are shown in FIG. 27.

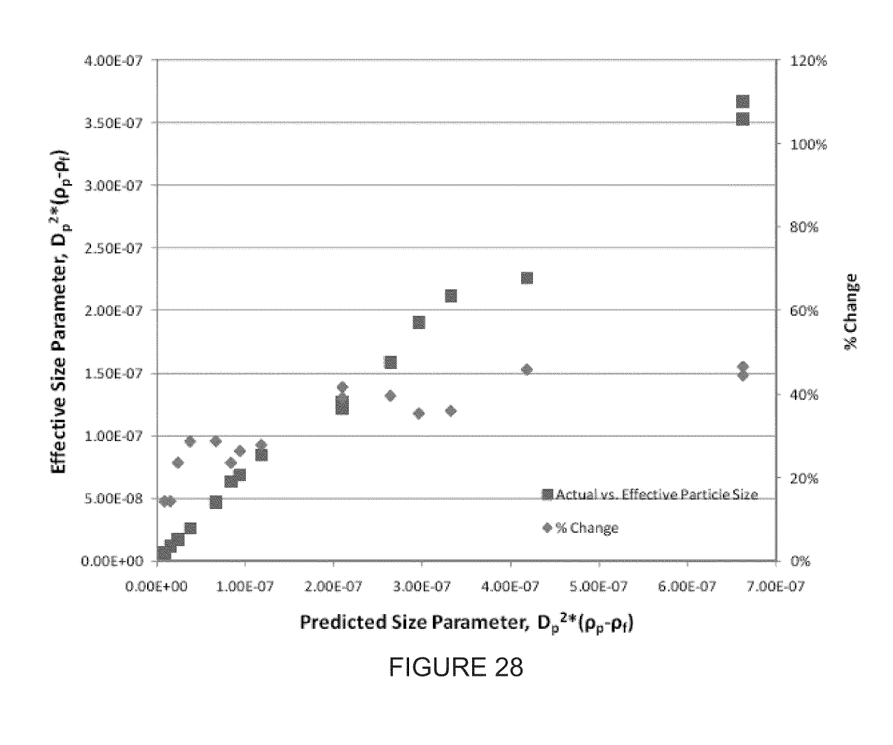

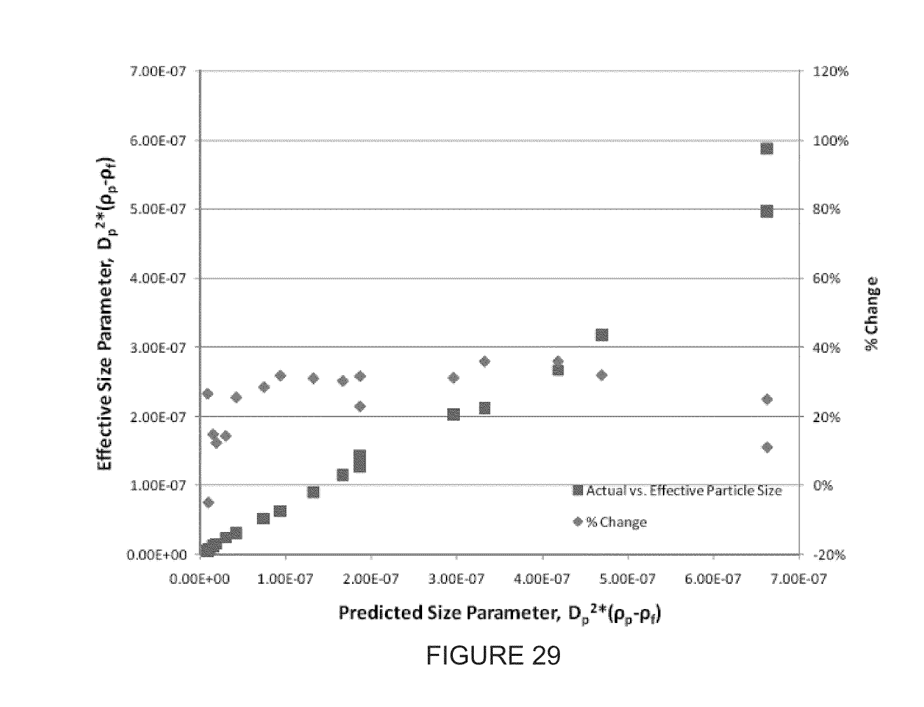

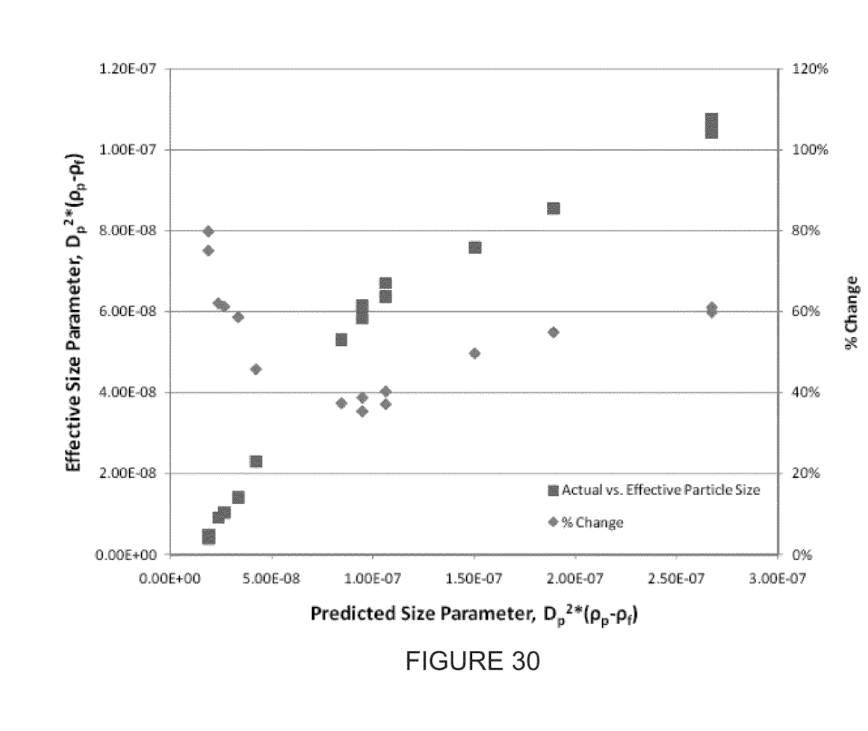

The Poly(acrylic acid: 2 acrylamide-2 methyl propane sulfonic acid) (PAA:AMPS) copolymer had an average molecular weight of 5,000 Daltons and resulted in the following observations.
At 100 ppm: The settling time increased by 18-42%, with larger improvements in the dispersion of larger particles. The results of this test are shown FIG. 28.
At 10,000 ppm: The settling time increased by ˜30%, although less improvement was observed at the extremes of the particle sizes examined. The results of this test are shown FIG. 29.
Hematite distribution: The settling time generally increased by ˜40-60%. A greater (80%) improvement in settling time was observed at low particle sizes (˜2 μm). The results of this test are shown FIG. 30.

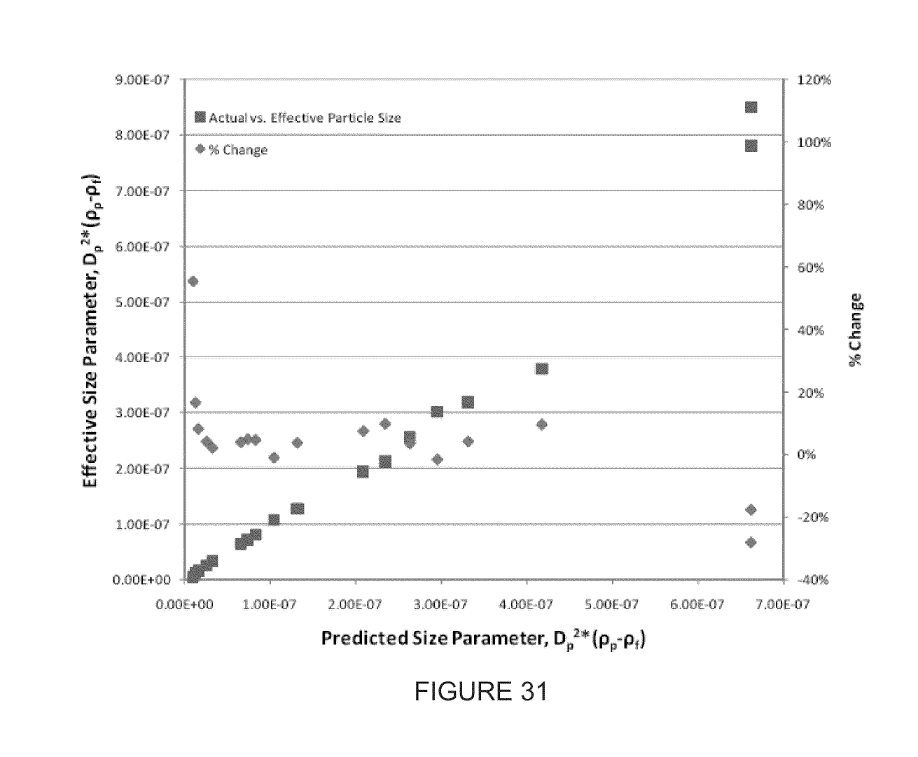

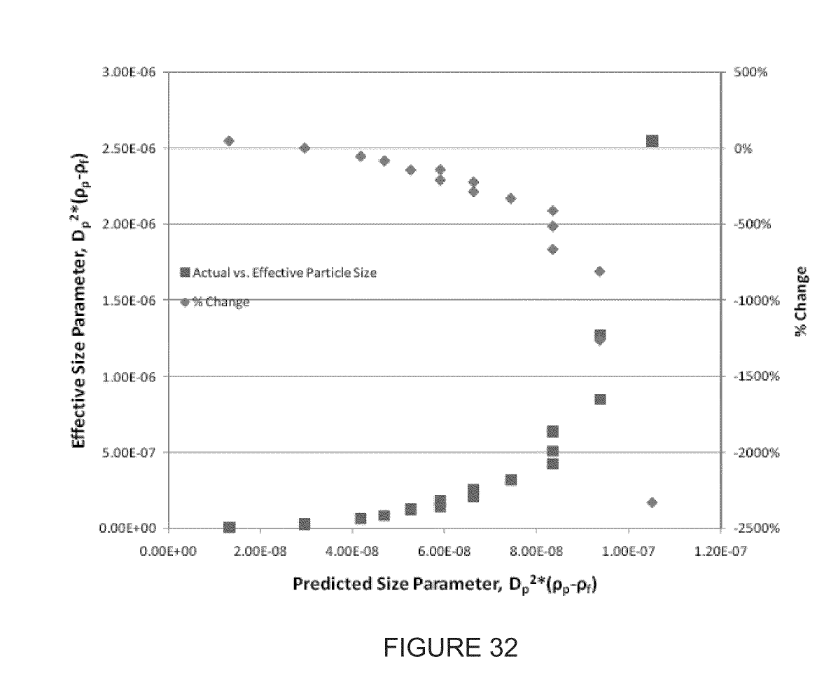

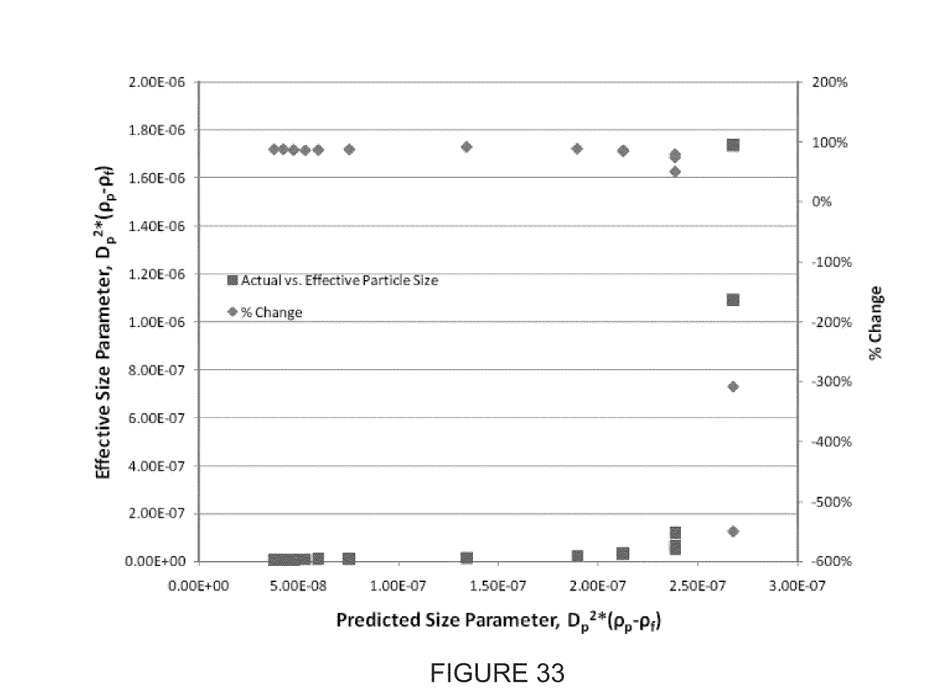

The poly(acrylamide-2-methyl propane sulfonic acid) (PAMPS) was the largest polymer tested, with an average molecular weight of 800,000 Daltons.
At 100 ppm: Little to no improvement in the settling rate was observed. The results of this test are shown FIG. 31.
At 10,000 ppm: The settling rate increased with increasing particle size. At particle diameters above ˜3.5 μm, the settling velocity was greatly accelerated. The results of this test are shown FIG. 32.
Hematite dispersion: With the exception of the anomalies observed at ˜8 μm, the settling time increased by between 70 and 90%. The results of this test are shown FIG. 33.

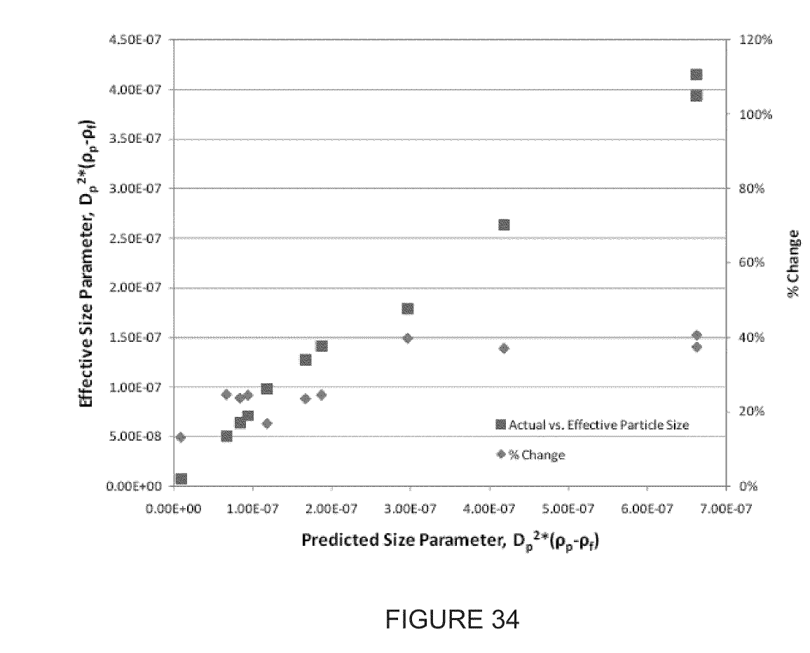

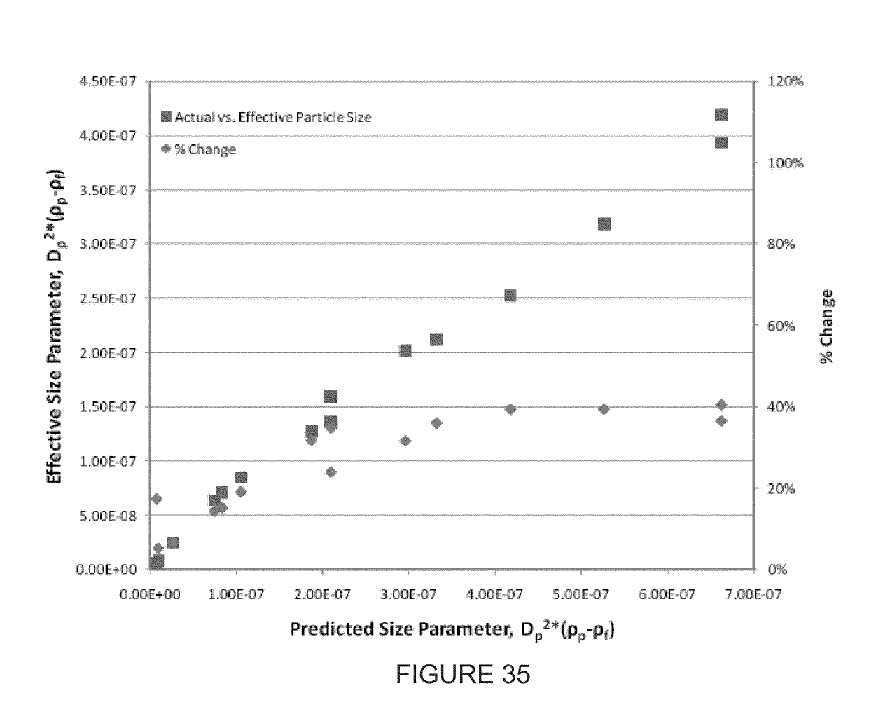

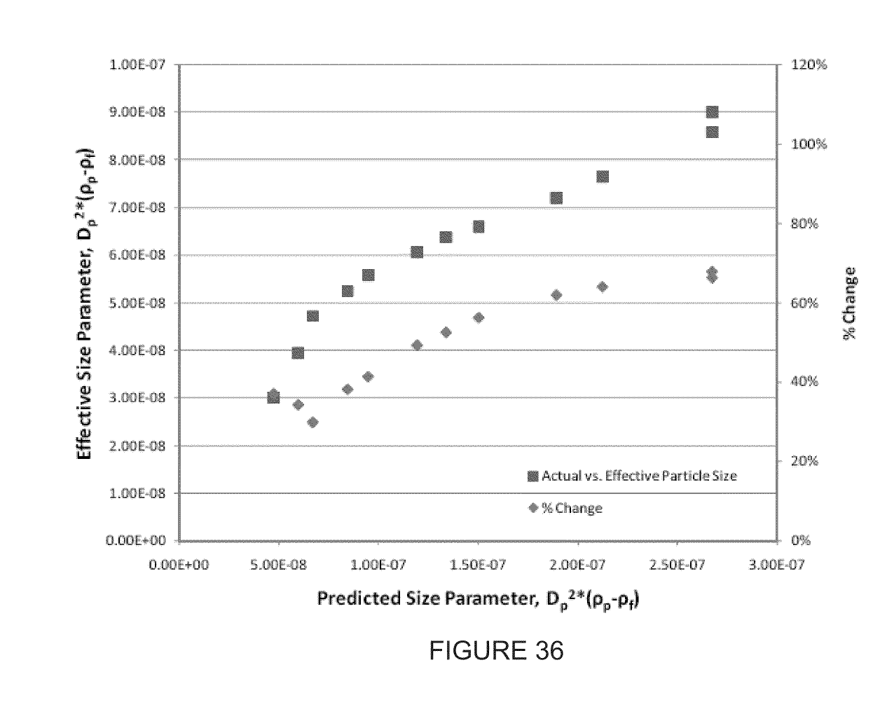

The poly(sulfonated styrene:maleic anhydride) (PMA:SS) copolymer had a molecular weight of ˜20,000 Daltons.
At 100 ppm: The settling time of particles >˜8 μm increased by ˜40%. Smaller particles took ˜20% more time to settle. The results of this test are shown FIG. 34.
At 10,000 ppm: Improvements in settling time similar to that seen at 100 ppm were observed, with the improvement decreasing with decreasing particle size. The results of this test are shown FIG. 35.
Hematite dispersion: The settling time of increased by ˜30-68%. The results of this test are shown in FIG. 36.

Recirculation procedures at three representative power producing facilities were reviewed to provide a baseline for evaluating dispersant application during long-path recirculation cleanup. The following parameters were typical of the long path recirculation for the three power producing facilities.
Flow rates for long-path recirculation cleanup process range from 2000-4000 gpm. This indicates that cycle times for the long-path recirculation cleanup application (i.e., the time necessary for all fluid to pass through the long-path loop once) are on the order of ˜1-2 hours, depending on the fluid volume of the system. Consequently, the time period that corrosion products must remain suspended in order to be removed from the secondary system is bounded by approximately 1-2 hours.
The recirculation cleanup period generally lasts for 1-2 days and is not on critical path. All three plants remain in long-path recirculation for a sufficient period of time to reach a steady-state iron removal.
Startup procedures are generally initiated from the long-path recirculation cleanup process, i.e., there are no additional drains or flushes prior to power ascension. Additional flushes may not be practical due to tight outage scheduling. The majority of the system remains at or around ambient temperature for the duration of the cleanup period.

The duration of the dispersant candidate tests was originally established at 10 minutes. This period is estimated to be representative of the recirculation time during the long-path clean-up. During long-path recirculation, the system volume typically turns over once every 10 minutes to 1 hour (depending on the flow rate and system volume). Additional mixing may occur as the flow passes through elbows, tees, expanders, etc., increasing particle suspension. In some areas, the flow may be turbulent, further increasing particle suspension. In the settling experiments performed, iron oxide particles traveled a maximum distance of 2.17 cm to settle on the bottom of the cuvette; this distance is significantly less than the average radius of typical feedwater and condensate lines. A typical suspended particle would therefore have a larger distance to settle, reducing the likelihood of early particle deposition.

Because the duration of a long-path recirculation application is much shorter (on the order of a few days), at lower temperature (layup temperatures), and in less critical assets than the steam generators, the use of higher dispersant concentrations or more chemically active dispersants are acceptable.

Since one of the objectives of this dispersant application is to increase the time that iron oxide particles spend in suspension, a relatively high deposit concentration (10,000 ppm) was used. The experiments performed focus on the suspension of either magnetite (Fe₃O₄) or hematite (Fe₂O₃) at a concentration of 10,000 ppm. In the results, the extent of settling has been measured by determining the light absorption of the suspension, i.e., the rate of settling is determined by the rate at which the clarity of the suspension increases. The list of the candidate dispersants and their properties is reproduced in Table 2. The raw data from all trials performed is included in Tables 3 through 7. Table 3 shows the results for 1:1 Magnetite:Dispersant Ratio (10,000 ppm); Table 4 shows the results for 1:100 Magnetite:Dispersant Ratio; Table 5 shows the results for 1:1000 Magnetite:Dispersant Ratio; Table 6 shows the results for 1:1 Hematite:Dispersant Ratio (10,000 ppm); and Table 7 shows the results for 1:1 Magnetite:Dispersant Ratio (100 ppm).

TABLE 2

| | | | | Predicted | Secondary | |
|---|---|---|---|---|---|---|
| | | | | Effectiveness | System | |
| | | | | for Iron Oxide | Materials | Commercial |
| # | Dispersant | Abbr. | MW | Dispersion | Compatibility | Availability |
| 1 | Polyacrylic Acid | PAA | 2,000 | Moderate | Good | Good |
| | | | 5,000 | | | |
| | | | N.P. | | | |
| 2 | Polymethacrylic Acid | PMAA | 6,500 | Moderate | Good | Good |
| 3 | Poly(acrylic acid:maleic acid) | PAA:MA | 3,000 | Moderate | Good | Moderate |
| 4 | Poly(Acrylic acid:acrylamide) | PAAM | 200,000 | Moderate | Good | Moderate |
| 5 | Poly(acrylic acid:2 acrylamide-2 | PAA:AMPS | 5,000 | High | Poor (Sulfur) | Proprietary |
| | methyl propane sulfonic acid) | | | | | |
| 6 | Poly(acrylic acid:sulfonic | PAA:SA:SS | N.P. | High | Poor (Sulfur) | Proprietary |
| | acid:sulfonated styrene) | | | | | |
| 7 | Poly(2-acrylamide-2 methyl propane | PAMPS | 800,000 | High | Poor (Sulfur) | Moderate |
| | sulfonic acid) | | | | | |
| 8 | Poly(sulfonic acid:acrylic acid) | PAA:SA | <15,000 | High | Poor (Sulfur) | Proprietary |
| 9 | Poly(sulfonated styrene:maleic | PMA:SS | 20,000 | High | Poor (Sulfur) | Proprietary |
| | anhydride) | | | | | |

TABLE 3

| | Deposit | | Dispersant | | Time to % Transmittance (Seconds) | | | | | |
|---|---|---|---|---|---|---|---|---|---|---|
| Test | | Conc. | | Conc. | 0.1% (initial | | | | | |
| # | Material | (ppm) | Polymer | (ppm) | reading) | 1% | 2% | 5% | 5 Min. | 10 Min. |
| 7 | M | 10,000 | 1 | 10,000 | 30 | 110 | 157 | 282 | 5.4 | 14 |
| 12 | M | 10,000 | 2 | 10,000 | 21 | 86 | 132 | 235 | >5.1 | 15.8 |
| 22 | M | 10,000 | 4 | 10,00 | 114 | 192 | 243 | 354 | 3.4 | 16.4 |
| 47 | M | 10,000 | 9 | 10,000 | 65 | 143 | 188 | 266 | 6.1 | 18 |
| 42 | M | 10,000 | 8 | 10,000 | 86 | 151 | 199 | 277 | 5.6 | 19.5 |
| 27 | M | 10,000 | 5 | 10,000 | 61 | 118 | 157 | 254 | 6.7 | 22.1 |
| 37 | M | 10,000 | 7 | 10,000 | 86 | 99 | 135 | 225 | 8.9 | 23.2 |
| 57 | M | 10,000 | 11 | 10,000 | 91 | 151 | 189 | 280 | 6.1 | 23.5 |
| 17 | M | 10,000 | 3 | 10,000 | 0 | 0 | <10 | <20 | 17.6 | 24.6 |
| 1 | M | 10,000 | — | — | 55 | 100 | 127 | 212 | 10.5 | 26.8 |
| 32 | M | 10,000 | 6 | 10,000 | 0 | 0 | 0 | 0 | 30.8 | 35.6 |
| 52 | M | 10,000 | 10 | 10,000 | 0 | 0 | 0 | 0 | 32.7 | 40 |

TABLE 4

| | Deposit | | Dispersant | | Time to % Transmittance (seconds) | | | | | |
|---|---|---|---|---|---|---|---|---|---|---|
| Test | | Conc. | | Conc. | 0.1% (initial | | | | | |
| # | Material | (ppm) | Polymer | (ppm) | reading) | 1% | 2% | 5% | 5 min. | 10 min. |
| 33 | M | 10,000 | 6 | 100 | 25 | 105 | 159 | 282 | 5.4 | 14.2 |
| 43 | M | 10,000 | 8 | 100 | 103 | 181 | 219 | 294 | 5.2 | 16.3 |
| 18 | M | 10,000 | 3 | 100 | 106 | 182 | 216 | 333 | 4.4 | 17 |
| 38 | M | 10,000 | 7 | 100 | 114 | 183 | 215 | 308 | 4.4 | 17.6 |
| 23 | M | 10,000 | 4 | 100 | 114 | 170 | 216 | 314 | 4.9 | 19.2 |
| 48 | M | 10,000 | 9 | 100 | 104 | 169 | 200 | 313 | 4.4 | 20.4 |
| 13 | M | 10,000 | 2 | 100 | 42 | 101 | 141 | 206 | 8.8 | 21.1 |
| 8 | M | 10,000 | 1 | 100 | 94 | 150 | 190 | 307 | 4.6 | 22 |
| 58 | M | 10,000 | 11 | 100 | 92 | 145 | 214 | 271 | 7.1 | 22.1 |
| 28 | M | 10,000 | 5 | 100 | 84 | 136 | 180 | 290 | 5.8 | 23.5 |
| 1 | M | 10,000 | — | — | 55 | 100 | 127 | 212 | 10.5 | 26.8 |
| 53 | M | 10,000 | 10 | 100 | 45 | 101 | 127 | 197 | 11 | 27.3 |

TABLE 5

| | Deposit | | Dispersant | | Time to % Transmittance (seconds) | | | | | |
|---|---|---|---|---|---|---|---|---|---|---|
| Test | | Conc. | | Conc. | 0.1% (initial | | | | | |
| # | Material | (ppm) | Polymer | (ppm) | reading) | 1% | 2% | 5% | 5 min. | 10 min. |
| 14 | M | 10,000 | 2 | 10 | 86 | 152 | 194 | 271 | 5.2 | 19.9 |
| 29 | M | 10,000 | 5 | 10 | 95 | 161 | 199 | 262 | 6.4 | 19.9 |
| 44 | M | 10,000 | 8 | 10 | 104 | 162 | 210 | 312 | 4.8 | 20 |
| 39 | M | 10,000 | 7 | 10 | 88 | 156 | 198 | 276 | 6.4 | 21 |
| 49 | M | 10,000 | 9 | 10 | 86 | 152 | 200 | 291 | 5.5 | 21.6 |
| 24 | M | 10,000 | 4 | 10 | 86 | 140 | 188 | 275 | 6.4 | 22.6 |
| 9 | M | 10,000 | 1 | 10 | 84 | 164 | 182 | 262 | 6.7 | 22.9 |
| 19 | M | 10,000 | 3 | 10 | 74 | 126 | 177 | 261 | 7.3 | 23 |
| 59 | M | 10,000 | 11 | 10 | 66 | 124 | 163 | <300 | 8.8 | 23.1 |
| 34 | M | 10,000 | 6 | 10 | 59 | 109 | 151 | 244 | 7.6 | 24.3 |
| 1 | M | 10,000 | — | — | 55 | 100 | 127 | 212 | 10.5 | 26.8 |
| 54 | M | 10,000 | 10 | 10 | 43 | 82 | 112 | 187 | 13 | 29.2 |

TABLE 6

| | Deposit | | Dispersant | | Time to % Transmittance (seconds) | | | | | |
|---|---|---|---|---|---|---|---|---|---|---|
| Test | | Conc. | | Conc. | 0.1% (initial | | | | | |
| # | Material | (ppm) | Polymer | (ppm) | reading) | 1% | 2% | 5% | 5 min. | 10 min. |
| 4 | H | 10,000 | — | — | 142 | 261 | 326 | 439 | 1.5 | 10.4 |
| 11 | H | 10,000 | 1 | 10,000 | <474 | 531 | 597 | 734 | 0 | 2.0 |
| 16 | H | 10,000 | 2 | 10,000 | 502 | 660 | 727 | 876 | 0 | 0.5 |
| 21 | H | 10,000 | 3 | 10,000 | 1653 | 2871 | 3403 | >3510 | 0 | 0 |
| 26 | H | 10,000 | 4 | 10,000 | 409 | 521 | 600 | >600 | 0 | 5.0 |
| 31 | H | 10,000 | 5 | 10,000 | 526 | 612 | >705 | >705 | 0 | 0.8 |
| 36 | H | 10,000 | 6 | 10,000 | 0 | 14 | 688 | 4875 | 1.7 | 1.9 |
| 41 | H | 10,000 | 7 | 10,000 | 352 | 448 | 505 | 637 | 0 | 3.9 |
| 46 | H | 10,000 | 8 | 10,000 | 355 | 440 | 497 | 636 | 0 | 4.1 |
| 51 | H | 10,000 | 9 | 10,000 | 355 | 447 | 504 | 622 | 0 | 4.0 |
| 56 | H | 10,000 | 10 | 10,000 | 22 | 1665 | >3090 | <3780 | 0.2 | 0.3 |
| 61 | H | 10,000 | 11 | 10,000 | 424 | 530 | 580 | 686 | 0 | 2.6 |

TABLE 7

| Time | | | | | | | | | | | | | |
|---|---|---|---|---|---|---|---|---|---|---|---|---|---|
| Elapsed | Transmittance (@ 458 nm, blanked to solution w/o magnetite) | | | | | | | | | | | Control | |
| (s) | Test 10 | Test 15 | Test 20 | Test 25 | Test 30 | Test 35 | Test 40 | Test 45 | Test 50 | Test 55 | Test 60 | Test 3a | Test 3b |
| 15 | 87.2 | 87.2 | 76.4 | 56.9 | 77.8 | 82.9 | 79.8 | 69.5 | 69.3 | 95.4 | 71.2 | 81.3 | 78.1 |
| 30 | 89.5 | 92.3 | 76.6 | 57.3 | 78.4 | 83.2 | 80.3 | 69.7 | 69.6 | 95.5 | 71.5 | 81.3 | 78.1 |
| 45 | 89.9 | 92.8 | 77.0 | 57.5 | 78.4 | 83.7 | 80.6 | 70.0 | 70.0 | 95.6 | 71.7 | 81.5 | 78.3 |
| 60 | 90.2 | 93.0 | 77.0 | 57.8 | 78.6 | 83.7 | 80.9 | 70.3 | 70.3 | 96.1 | 71.9 | 81.6 | 78.3 |
| 75 | 90.3 | 93.0 | 77.1 | 58.2 | 78.7 | 83.9 | 81.2 | 70.7 | 70.6 | 96.1 | 72.2 | 81.7 | 78.4 |
| 90 | 90.4 | 93.1 | 77.3 | 58.5 | 78.8 | 84.1 | 81.4 | 71.0 | 70.9 | 96.2 | 72.4 | 81.8 | 78.5 |
| 120 | 90.6 | 93.5 | 77.6 | 59.1 | 79.1 | 84.5 | 82.0 | 71.5 | 71.1 | 96.2 | 72.8 | 82.0 | 78.7 |
| 150 | 90.5 | 93.5 | 77.7 | 59.6 | 79.4 | 84.7 | 82.5 | 71.8 | 71.5 | 96.6 | 73.1 | 82.1 | 79.0 |
| 180 | 90.9 | 93.693.6 | 77.9 | 60.1 | 79.6 | 85.0 | 82.8 | 72.2 | 72.0 | 96.8 | 73.2 | 82.2 | 79.0 |
| 210 | 91.1 | 93.793.6 | 78.2 | 60.5 | 79.8 | 85.1 | 83.0 | 72.4 | 72.2 | 96.9 | 73.4 | 82.4 | 79.2 |
| 240 | 91.2 | 93.893.7 | 78.5 | 60.7 | 79.9 | 85.2 | 83.4 | 72.7 | 72.5 | 97.0 | 73.6 | 82.5 | 79.2 |
| 270 | 91.3 | 93.893.8 | 78.6 | 61.3 | 79.9 | 85.2 | 83.6 | 72.9 | 72.7 | 97.0 | 73.8 | 82.6 | 79.3 |
| 300 | 91.6 | 93.8 | 78.6 | 61.6 | 80.0 | 85.3 | 83.8 | 73.1 | 73.0 | 97.0 | 74.0 | 82.7 | 79.3 |
| 330 | 91.8 | 93.9 | 78.6 | 61.9 | 80.0 | 85.4 | 84.1 | 73.2 | 73.2 | 97.2 | 74.1 | 82.8 | 79.5 |

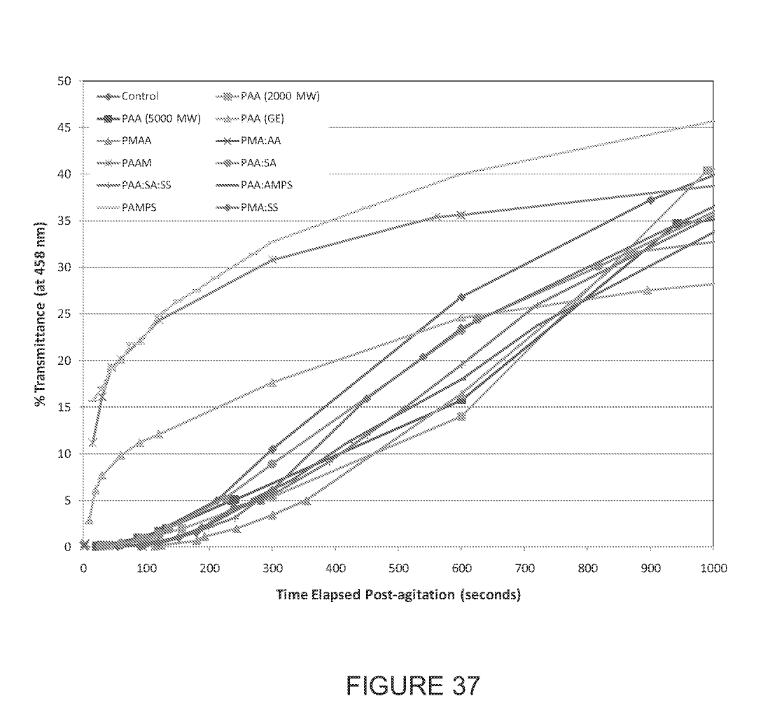

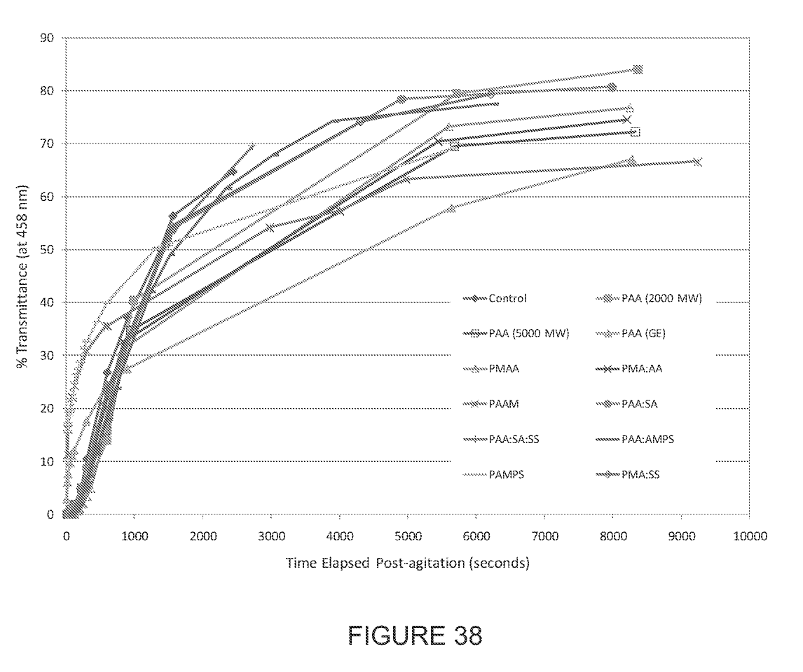

An initial dispersant concentration of 10,000 ppm was selected to yield a dispersant:iron oxide ratio of 1:1. The results of these tests are shown in graphical form in FIG. 37. Several tests were allowed to continue beyond the initial ten minute interval. The results of these tests are shown in FIG. 38.

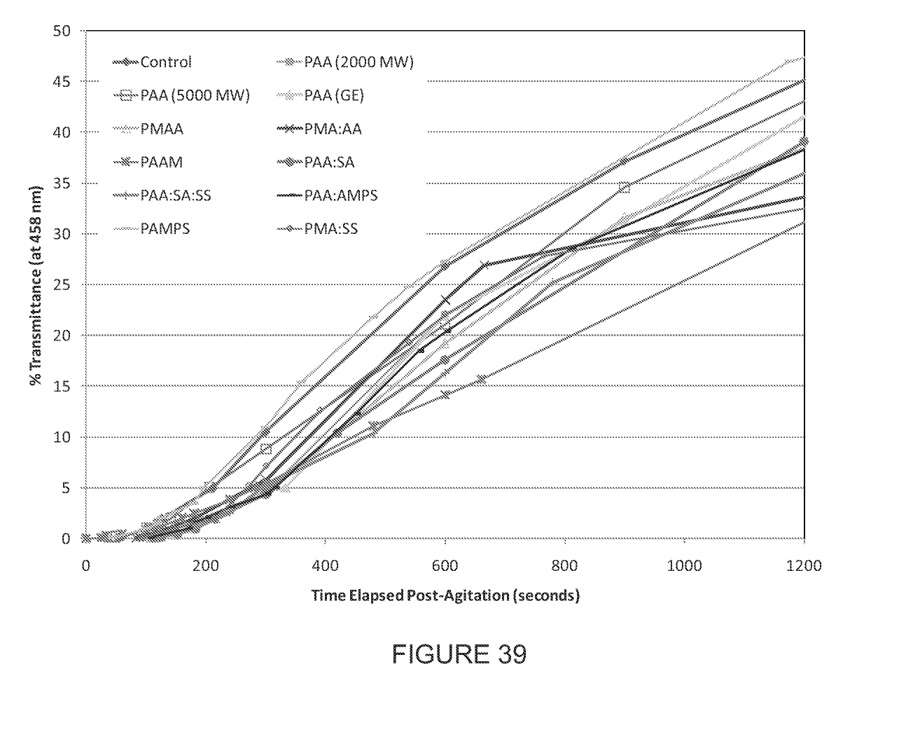

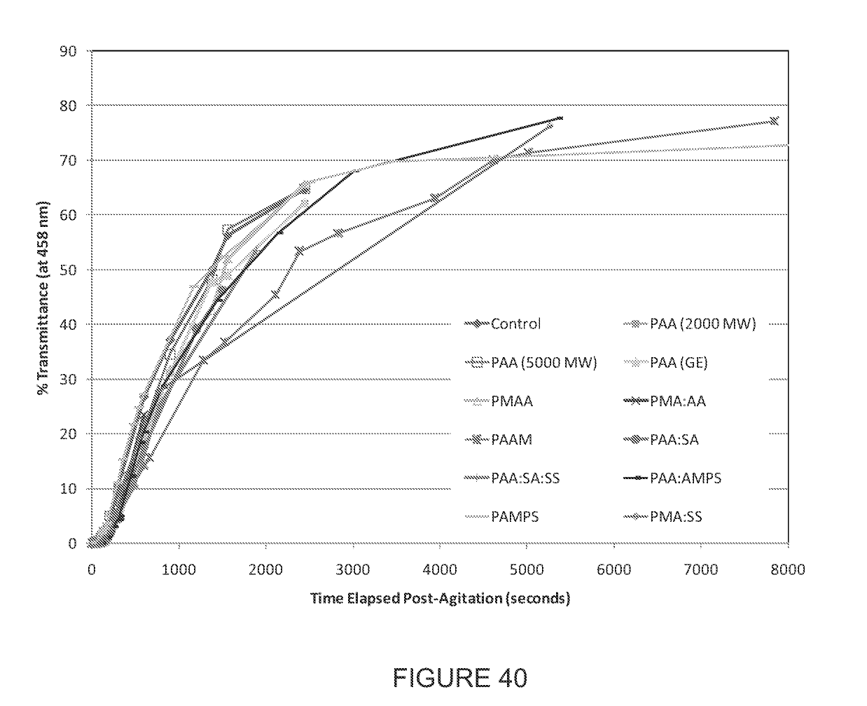

Because a dispersant concentration of 10,000 ppm may not be practical (due to concerns with materials compatibility, cost, etc.), the efficacy of the candidate dispersants was also evaluated at dispersant concentrations of 100 ppm and 10 ppm (corresponding to 1:100 and 1:1000 dispersant:iron oxide ratios, respectively). The results of the screening tests performed with 100 ppm dispersant are shown in FIG. 39. Several tests were allowed to continue for an extended period of time; these results are shown in FIG. 40.

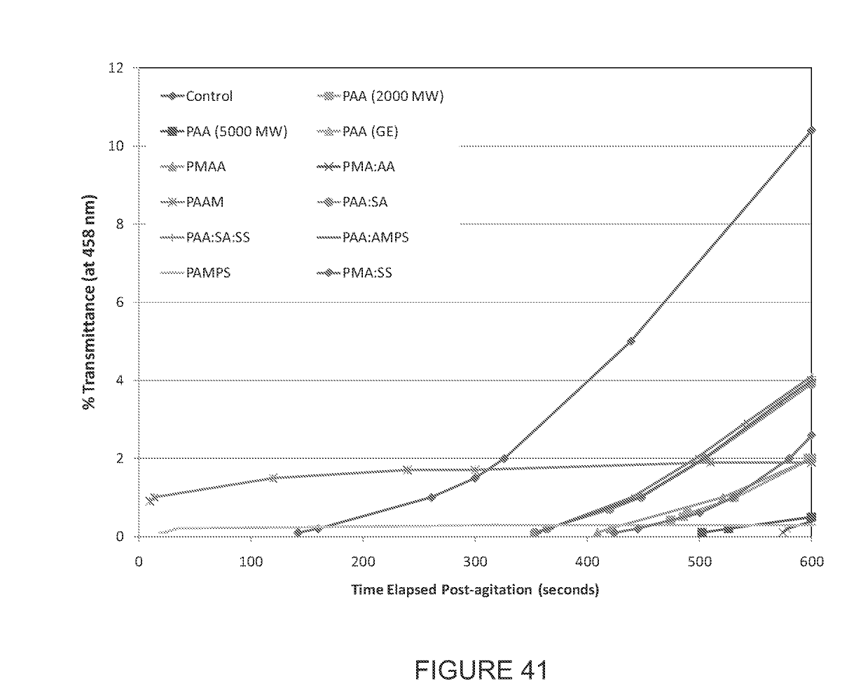

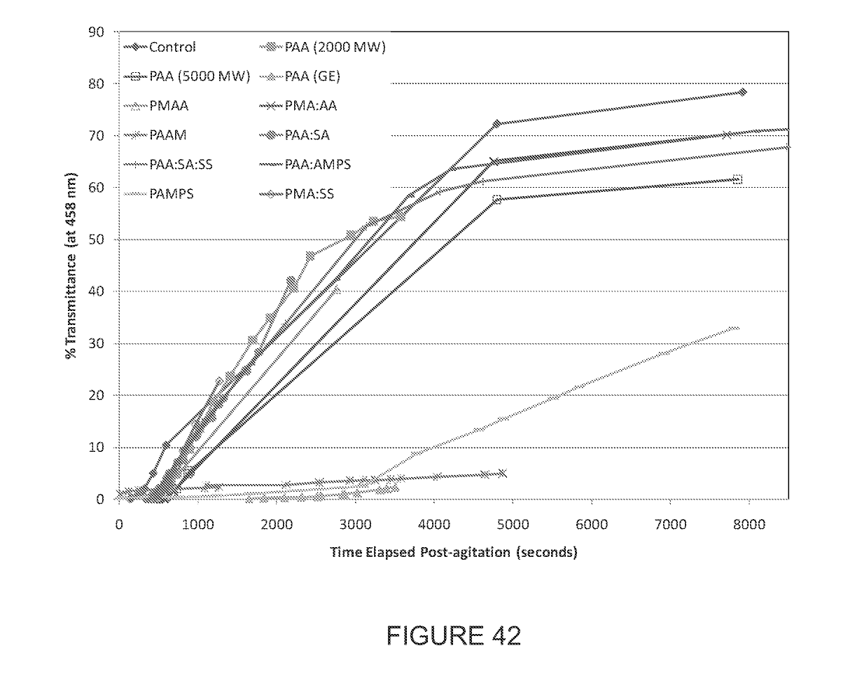

In some areas of the secondary system, particularly areas of the feedwater system that experience relatively low temperatures during normal operation, deposits are primarily composed of hematite (Fe₂O₃). The efficacy of candidate polymers at dispersing hematite was therefore evaluated. The results of the dispersant screening tests performed with 10,000 ppm hematite are shown in FIG. 41. As before, later tests were continued for an extended period of time; the results of these tests are shown in FIG. 42.

Dispersants-material compatibility was also evaluated to assess the feasibility of dispersant application in a secondary system. The dispersants were tested with various materials such as nickel-based alloys, carbon and low alloy steels, stainless steels, elastomers, ion exchange resins, copper alloys, titanium and titanium alloys, and graphite materials.

As a result, it was determined that the following guidance should be applied to an initial industry plant application trial.
A dispersant concentration of 1 ppm is recommended as a starting point for an initial plant application. The concentration may be gradually increased within the outage window or in subsequent applications as more data on the actual plant response become available.
It is recommended that the dispersant be fed through a metering pump to avoid overfeeding. The injection location should be: a) far enough upstream of the condenser to allow adequate mixing, and b) downstream of the condensate polishers to maximize the contact time of the dispersant with corrosion products and to prevent local regions of high dispersant concentration from contacting the resins.
For the proposed initial application at 1 ppm (for example), dispersant addition should be initiated ˜36 hours after long-path recirculation is established. Data from the three plants surveyed indicate that the majority of the easily removable corrosion products will have been eliminated by this time. The exact timing of the addition of dispersant is somewhat flexible. If possible, the cleanup solution should be sampled prior to dispersant injection to ensure that the iron concentration is <100 ppb prior to dispersant injection. This injection schedule is based on maximizing the effectiveness of a limited injection of dispersant. In future applications in which the concentration of dispersant is increased or is initially higher, injection could be made earlier.
If the long-path recirculation cleanup period is anticipated to last less than 36 hours, dispersant injection should be initiated earlier, and at least 8 hours before feedwater is introduced to the steam generators. This will allow the fluid in the condenser hotwells to turnover at least 4 times, giving the dispersant ample time to act on any dispersible material and potentially be removed by the condensate polishers.
A plant-specific system compatibility review should be completed prior to performing dispersant application during the long-path recirculation cleanup process to ensure that the addition of dispersant will not have unintended or unplanned consequences. Specifically, the effect of significantly increased deposit loading on the condensate polishers and the potential effect on flow measurement devices should be considered.

Following the settling tests, additional experiments were conducted to evaluate dispersant performance under dynamic conditions. It was determined that in addition to enhancing the retention of iron in solution, dispersant addition may promote the resuspension of iron oxides that have previously settled in the secondary system during the shutdown and layup periods. The experiments evaluated the ability of the candidate dispersants to resuspend deposited material under dynamic conditions. Based on the results of the tests discussed above, three candidate dispersants were selected for additional testing under dynamic (flow) conditions: PAA (high molecular weight), PMAA, and PAA (low molecular weight). The objective of these experiments was to determine if these dispersants would resuspend previously deposited material, and if so, to qualitatively evaluate the differences in performance between the selected dispersant candidates under dynamic conditions.

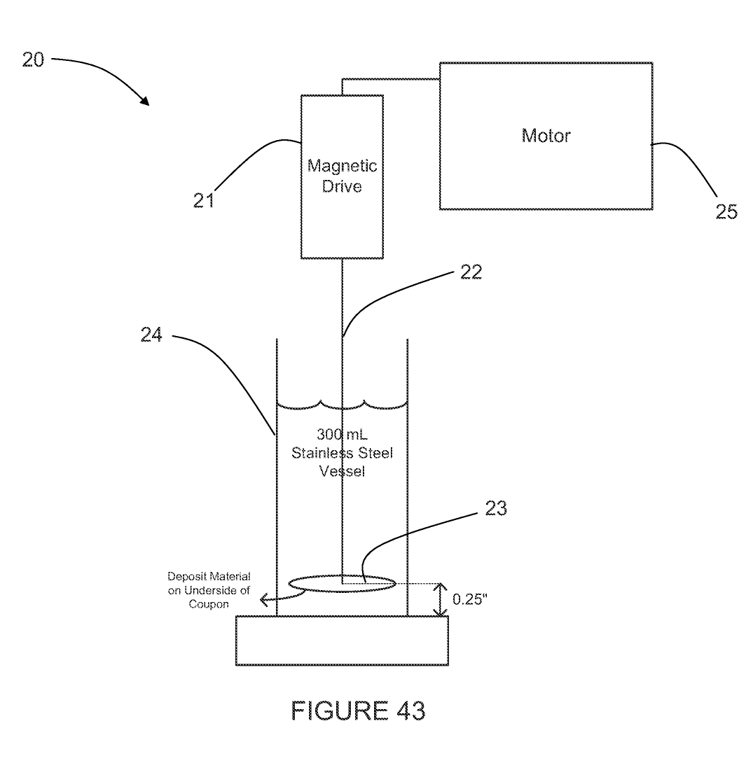

An experimental apparatus 20, shown in FIG. 43, was designed to simulate the flow stresses present during the long-path recirculation cleanup process. The experimental inputs are described below.

Stainless steel coupons 23 coated with a 10 mil thick layer of deposit material were used to simulate corrosion products deposited on secondary system pipe surfaces. These coupons 23 were immersed in a test solution (deionized water, with or without dispersant) and rotated to generate a fluid shear stress characteristic of that experienced near the surface of the piping during the long-path recirculation cleanup process. The remainder of this section describes the major components of the experimental apparatus.

The simulated plant deposit materials used in these tests (synthetic magnetite and hematite) were identical to those used in the settling tests. A mixture of the appropriate iron oxide and deionized water was applied to one surface of each stainless steel coupon 23. The excess was removed using a calendar to create an even coating. Once the deposit material was applied, the coupons 23 were heated according to the following schedule:

3 hours at 100° C.

3 hours at 150° C.

3 hours at 225° C.

3 hours at 280° C.

Nitrogen was passed over the coupons 23 throughout the heating process to prevent oxidation. At the end of the heating cycle, the coupons 23 were allowed to cool to room temperature before being loaded into the experimental apparatus 20.

The stainless steel coupons 23 used in this test measured 2.07″ in diameter and 0.03″ thick. Prior to deposit loading, a hole was drilled through the center of each coupon 23 and one side was etched with an identification number. The test coupons 23 were then prepared by cleaning and roughening the non-etched surface with emery paper. The deposit material was then applied to this side as described above. At the start of each test, the pre-coated coupon 23 was attached to the end of drive shaft 22 and positioned such that it was suspended in fluid contained in a vessel 24 (deposit-coated surface facing downward) within 0.25 inches of the vessel floor.

The experimental apparatus 20 was assembled in an autoclave bay. This bay is fitted with a variable speed magnetic drive and motor 21, which could be connected to shaft 22 and rotated at a specified frequency. For each test, a stainless steel coupon 23 pre-loaded with deposit material was attached to the end of the shaft 22 extending down from the magnetic drive 21 via a hole drilled through the coupon's center. The coupon 23 was immersed in a solution of deionized water (with or without dispersant) at ambient temperature. The coupon 23 was attached to the shaft 22 such that the surface coated with deposit material faced downward, and was suspended ¼″ above the floor of the vessel 24 containing the test solution.

The rotation of the coupon 23 created a radial distribution of fluid velocities across the surface of the coupon 23, which produced varying shear stresses. In order to approximate the forces present on previously-deposited material present in the long-path recirculation loop, a characteristic fluid velocity was calculated based on a representative plant geometry.

The average velocity of the fluid in the system, u, was found by dividing the known flow rate by the cross sectional area of the flow path using the following information:
The typical flow rate of representative plant during the long path recirculation cleanup process is estimated at 4,000 gpm.
It is assumed that flow is equally distributed between the two heater trains, the total flow rate through the feedwater heater during long-path recirculation is 4000 gpm/2=2000 gpm (4.456 ft³/s).
The heater tubing is specified to have an OD of 0.625 inches and a thickness of 0.035 inches from which it can be determined that the inner diameter is 0.625 inches−0.035 inches=0.59 inches.
Each heater contains a total of 1397 tubes.
   The total area of the flow path is therefore:

$$1397 tubes \times {( \frac{.59 in}{2} )}^{2} \times π = 382 {in}^{2} = 2.65 {ft}^{2}$$

The average fluid velocity through the heater is then

$$u = \frac{4.456 {ft}^{3} \text{/} s}{2.65 {ft}^{2}} = 1.68 ft \text{/} s$$

To ensure that the range of fluid velocities experienced by different points on the coupon 23 were similar to the range of superficial velocities experienced by the tube wall during a typical long-path cleanup procedure, the speed of the motor 21 was set at 230 rpm. At this rate, approximately half of the area of the coupon 23 rotates at a velocity of greater than 1.68 ft/s, and half of the area rotates at a slower velocity.

Tests were conducted over a 24-hour period, as measured from the time that rotation of the coupon 23 was initiated. A 5 ml sample of the test solution was collected at 0.5, 1, 2, 5, 10, and 24 hours for elemental analysis to determine the iron content of the solution. Once the coupon 23 had started rotating, it remained rotating at the same speed until after the 24-hour sample had been collected (samples were collected from the flowing solution). Once the motor 21 had been turned off, the vessel 24 containing the test solution was removed and the solution transferred to a sealable bottle for analysis. The coupon 23 was then disconnected from the shaft 22 and dried at 30° C. under an inert gas.

Once dry, the coupon 23 was massed to determine the weight of the lost deposit material. The amount of resuspended deposit material was determined both from elemental analysis of samples of the test solution taken throughout the test (suspended iron) and from weight loss measurements at the start and end (gross particulates). Elemental analysis of the samples was performed with an inductively-coupled plasma spectrometer (ICP).

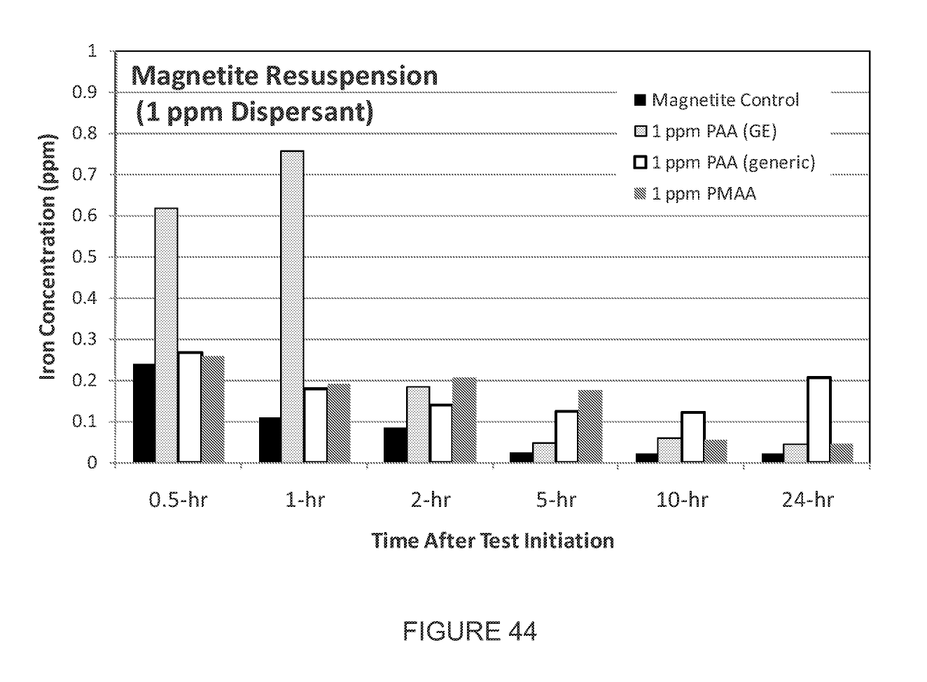

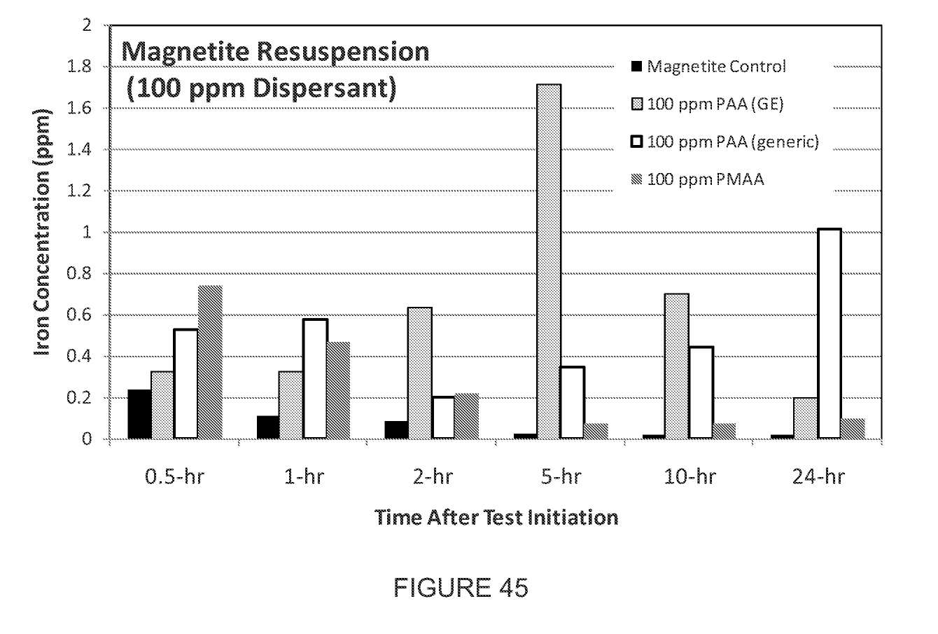

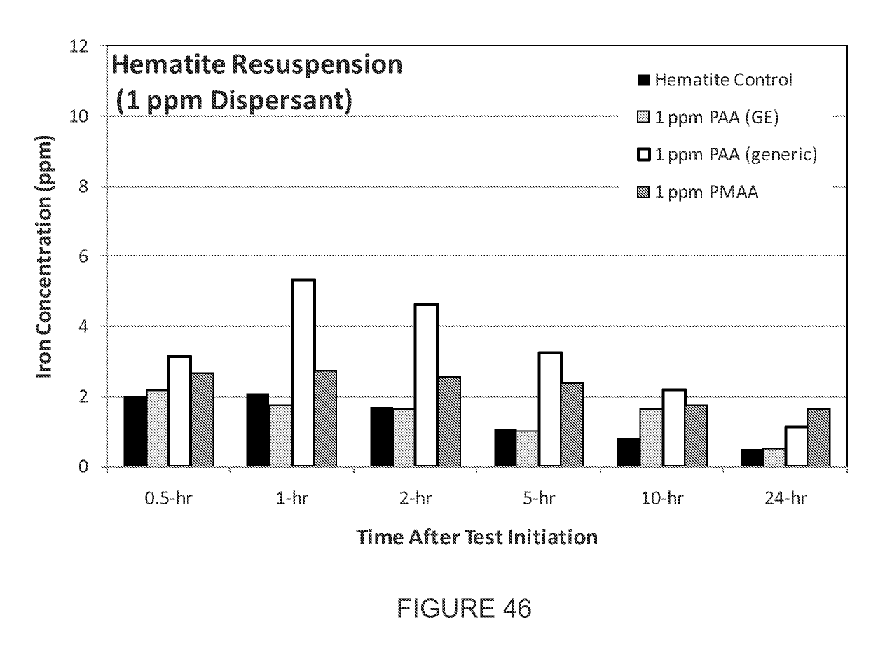

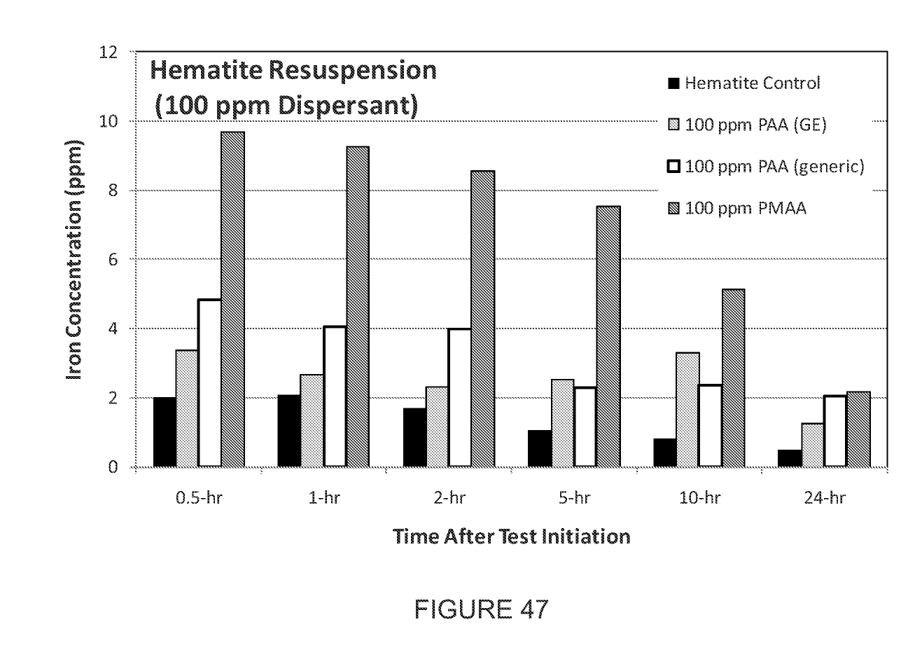

The results of the ICP analysis performed at each sampling interval (0.5, 1, 2, 5, 10, and 24 hours) for the resuspension tests performed are shown in Table 8. The results of tests performed with magnetite (Tests 1-7) are shown graphically in FIG. 44 (1 ppm dispersant) and FIG. 45 (100 ppm dispersant). FIG. 46 and FIG. 47 show the results of Tests 8-14, in which hematite was used as the deposit material. Standards were run after each test to verify that all measurements were within a 10% tolerance. The standards measured after the 1-hour and 2-hour samples for Test 10 (100 ppm high molecular weight PAA with hematite) fell below the acceptable range—that is, they understated the actual iron concentration. It is therefore possible that the actual iron content of these solutions is 20% greater; however, as it is unclear when the shift in instrument readings occurred, this cannot be stated with confidence. The measured values for all other standards were within the acceptable range.

TABLE 8

| | Test ID: | | | | | | |
|---|---|---|---|---|---|---|---|
| | Test 1 | | | | | | |
| | (control) | Test 2 | Test 3 | Test 4 | Test 5 | Test 6 | Test 7 |
| Deposit | Magnetite | Magnetite | Magnetite | Magnetite | Magnetite | Magnetite | Magnetite |
| Material | | | | | | | |
| Dispersant | none | PAA (HMW) | PAA (HMW) | PAA (LMW) | PAA (LMW) | PMAA | PMAA |
| Dispersant | N/A | 1 | 100 | 1 | 100 | 1 | 100 |
| Conc. (ppm) | | | | | | | |
| 0.5-hr | 0.24 | 0.62 | 0.33 | 0.27 | 0.53 | 0.26 | 0.74 |
| 1-hr | 0.11 | 0.76 | 0.33 | 0.18 | 0.58 | 0.19 | 0.47 |
| 2-hr | 0.08 | 0.19 | 0.64 | 0.14 | 0.20 | 0.21 | 0.22 |
| 5-hr | 0.02 | 0.05 | 1.75 | 0.12 | 0.35 | 0.18 | 0.07 |
| 10-hr | 0.02 | 0.06 | 0.71 | 0.12 | 0.44 | 0.05 | 0.07 |
| 24-hr | 0.02 | 0.05 | 0.20 | 0.21 | 1.01 | 0.05 | 0.10 |
| | Test ID: | | | | | | |
| | Test 8 | Test 9 | Test 10 | Test 11 | Test 12 | Test 13 | Test 14 |
| Deposit | Hematite | Hematite | Hematite | Hematite | Hematite | Hematite | Hematite |
| Material | | | | | | | |
| Dispersant | none | PAA (HMW) | PAA (HMW) | PAA (LMW) | PAA (LMW) | PMAA | PMAA |
| Dispersant | N/A | 1 | 100 | 1 | 100 | 1 | 100 |
| Conc. (ppm) | | | | | | | |
| 0.5-hr | 2.00 | 2.17 | 3.38 | 3.14 | 4.85 | 2.66 | 9.68 |
| 1-hr | 2.07 | 1.75 | 2.69 | 5.33 | 4.06 | 2.76 | 9.24 |
| 2-hr | 1.71 | 1.67 | 2.33 | 4.62 | 3.99 | 2.58 | 8.54 |
| 5-hr | 1.06 | 1.02 | 2.54 | 3.24 | 2.31 | 2.38 | 7.53 |
| 10-hr | 0.82 | 1.64 | 3.31 | 2.18 | 2.36 | 1.75 | 5.14 |
| 24-hr | 0.51 | 0.53 | 1.26 | 1.14 | 2.05 | 1.65 | 2.17 |

The mass of each coupon 23 was recorded before deposit loading, after deposit loading, and at the conclusion of the test period to determine the amount of deposit material lost by the coupon 23 over the course of the test. The majority of this material was released into the test solution as flakes or large particulates, which rapidly settled to the bottom of the vessel (0.25″ below the surface of the coupon). Upon removal of the coupon 23, a small inventory of deposit material roughly ½ inches in diameter was found to have collected at the center of the vessel floor, where the flow velocities were lowest.

Because the large flakes are believed to have detached from the coupon 23 due to the shearing force of the fluid and not through dispersant action, the results of the ICP analysis are believed to best reflect the efficacy of the dispersant (its ability to retain small particles in solution). Evidence of the flow patterns created by the rotation of the coupon 23 could be observed in the deposit material remaining on the coupons.

In general, the measured iron content was higher in solutions containing 100 ppm dispersant. However, the relative improvements in performance observed at 100 ppm were significantly less than would be expected for a factor of 100 increase, given that an increase in the amount of dispersant available would theoretically result in a proportional increase in iron suspension. In the tests evaluating the resuspension of magnetite, the presence of 100 ppm of dispersant resulted in iron concentrations that were an average of 2 to 3 times higher than those observed with 1 ppm of the same dispersant. This corresponds to a factor of 2 to 3 increase in effectiveness with a factor of a hundred increase in concentration. The relative increases in the effectiveness of solutions containing 100 ppm versus 1 ppm dispersant are shown in Table 9.

TABLE 9

| | Magnetite Suspension | | | Hematite Suspension | | |
|---|---|---|---|---|---|---|
| | PAA | PAA | | PAA | PAA | |
| Time Period | (HMW) | (LMW) | PMAA | (HMW) | (LMW) | PMAA |
| First 2 hours | −52% | 159% | 166% | 55% | 15% | 249% |
| 2-24 hours | 1318% | 220% | 24% | 107% | 11% | 168% |
| OVERALL | 861% | 199% | 71% | 90% | 13% | 195% |

Negative values indicate that the 1 ppm dispersant solution was more effective than the 100 pppm dispersant solution.

Because the time required for the fluid to circulate through the entire flow path (and therefore the condensate polishers and/or filters) is on the order of 30 minutes to 2 hours, it is not necessary for the dispersant to promote long-term particle suspension in order to be effective. The majority of the test results indicate that a dispersant concentration of 1 ppm is sufficient to significantly increase the iron oxide dispersion over a period of 2 hours. As this is the estimated cycle time for one pass through the condensate polishers during the long-path cleanup, assessment of the action of the dispersant can be limited to this time frame.

The percent improvement in iron oxide suspension observed in each test containing dispersant is shown in Table 10 and Table 11 (for testing performed with magnetite and hematite deposit materials, respectively). Although all three dispersants significantly increased the suspension of iron oxides under dynamic conditions, the greatest increase in magnetite concentration was observed in the test solution containing 1 ppm of the high molecular weight PAA polymer at the time periods of interest (1- and 2-hour sampling points). These data indicate that the high molecular weight formulation of PAA will be most effective at dispersing corrosion products consisting of magnetite until they can be removed from the system.

TABLE 10

| Test No. | Test 2 | Test 3 | Test 4 | Test 5 | Test 6 | Test 7 |
|---|---|---|---|---|---|---|
| Dispersant | PAA (HMW) | PAA (HMW) | PAA (LMW) | PAA (LMW) | PMAA | PMAA |
| Dispersant | 1 | 100 | 1 | 100 | 1 | 100 |
| Conc. (ppm) | | | | | | |
| 0.5-hr | 160% | 37% | 12% | 122% | 9% | 211% |
| 1-hr | 602% | 202% | 67% | 434% | 76% | 332% |
| 2-hr | 121% | 655% | 65% | 140% | 145% | 158% |

TABLE 11

| Test No. | Test 9 | Test 10 | Test 11 | Test 12 | Test 13 | Test 14 |
|---|---|---|---|---|---|---|
| Dispersant | PAA (HMW) | PAA (HMW) | PAA (LMW) | PAA (LMW) | PMAA | PMAA |
| Dispersant | 1 | 100 | 1 | 100 | 1 | 100 |
| Conc. (ppm) | | | | | | |
| 0.5-hr | 9% | 69% | 57% | 143% | 33% | 384% |
| 1-hr | −15% | 30% | 157% | 96% | 33% | 346% |
| 2-hr | −2% | 36% | 170% | 133% | 51% | 399% |

Contrary to the results of the preliminary settling tests, the high molecular weight PAA formulation performed less effectively compared to the other two dispersant candidates (and the control) in the resuspension tests with hematite. The iron oxide concentration of this test solution was slightly higher than that of the control solution.

In summary, the resuspension tests provided the following results.
A dispersant concentration of 1 ppm is sufficient to significantly increase magnetite dispersion.
Greater iron resuspension was generally observed in tests with elevated dispersant concentrations (100 ppm) compared to those with 1 ppm dispersant. However, the increase in efficacy is not proportional as might be anticipated from theoretical considerations.
The majority of the test results indicate that a dispersant concentration of 1 ppm is sufficient to significantly increase the iron oxide dispersion for a period of about 2 hours. Because the time required for the fluid to circulate through the entire flow path (and therefore the condensate polishers and/or filters) is on the order of 30 minutes to 2 hours, this time period is sufficient for the dispersant to be effective (a suspension time that is greater than or equal to the cycle time ensures that suspended material will reach the condensate polishers before depositing in the system).
Although all three dispersants significantly increased the suspension of iron oxides under dynamic conditions, the greatest increase in magnetite concentration was observed in the test solution containing 1 ppm of the high molecular weight PAA polymer at the time periods of interest (1- and 2-hour sampling points).
The high molecular weight PAA formulation did not perform as well as the other two dispersant candidates in the resuspension tests with hematite.

The foregoing has described a method of cleaning recirculation paths for a power producing facility. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. A method for reducing corrosion product transport in a power producing facility, comprising the steps of:
(a) selecting a chemical dispersant adapted to reduce the deposition of corrosion products in the recirculation path; and
(b) using at least one chemical injector to inject the chemical dispersant into a fluid contained in the recirculation path during recirculation path cleanup to increase corrosion product removal.

2. The method according to claim 1, further including the step of conducting a plant specific review to determine chemical dispersant compatibility with the power producing facility.

3. The method according to claim 1, wherein the step of selecting a chemical dispersant includes the steps of:
(a) determining the chemical dispersant's ability to decrease particle settling velocity; and
(b) determining the chemical dispersant's compatibility with materials contained in the power producing facility.

4. The method according to claim 3, wherein the settling velocity is determined by measuring a transmittance of a solution of chemical dispersant and fluid contained in the recirculation path.

5. The method according to claim 1, further including the step of determining an injection rate for the recirculation path.

6. The method according to claim 5, wherein the injection rate is determined by factors selected from the group consisting of an estimated corrosion product loading, existing system configuration, and outage and startup schedule.

7. The method according to claim 1, further including the step of recirculating the recirculation path.

8. The method according to claim 1, further including the step of removing the corrosion product from the recirculation path.

9. The method according to claim 1, further including the step of removing the dispersant from the recirculation path.

10. The method according to claim 1, further including the step of recirculating the recirculation path a pre-determined amount of time prior to injecting the chemical dispersant to remove easily removable corrosion products from the recirculation path prior to injection of the chemical dispersant.

11. The method according to claim 1, wherein the at least one chemical injector is positioned at a pre-determined location to allow adequate mixing with and maximize contact time between the chemical dispersant and the corrosion products.

12. The method according to claim 1, wherein the chemical dispersant is a polymeric dispersant.

13. The method according to claim 12, wherein the polymeric dispersant is selected from the group consisting of PAA, PMAA, PMA:AA, PAAM, PAA:SA, PAA:SS:SA, PAA:AMPS, PAMPS, and PMA:SS.

14. A method of testing resuspension characteristics of a chemical dispersant, comprising the steps of:
(a) providing a testing apparatus, comprising:
(i) a solution containment vessel;
(ii) a drive system; and
(iii) a shaft;
(b) attaching a substrate coated with deposit material to the shaft;
(c) immersing the coated substrate in a solution contained in the vessel;
(d) using the drive system to rotate the shaft and coated substrate at a predetermined velocity; and
(e) determining an amount of deposit material removed from the substrate.

15. The method according to claim 14, further including the step of weighing the substrate prior to being coated with the deposit material.

16. The method according to claim 14, further including the step of weighing the substrate after being coated with the deposit material.

17. The method according to claim 14, further including the step of weighing the substrate after the substrate is removed from the solution.

18. The method according to claim 14, further including the steps of collecting samples of the solution at pre-determined time intervals during testing to determine an elemental content of the solution.

19. The method according to claim 14, wherein the amount of deposit material removed is determined by an amount of elemental content contained in the solution and an weight of deposit material removed from the substrate.

20. The method according to claim 14, further including the step of coating the substrate with the deposit material.

21. The method according to claim 20, wherein the step of coating the substrate includes the steps of:
(a) applying a pre-determined amount of deposit material to the substrate;
(b) removing excess deposit material from the substrate;
(c) heating the coated substrate;
(d) passing nitrogen over the coated substrate during the heating step to prevent oxidation; and
(e) cooling the coated substrate to room temperature.

22. A method of reentraining existing deposits in a recirculation path, comprising the steps of:
(a) selecting a chemical dispersant adapted to suspend corrosion products in the recirculation path;
(b) using at least one chemical injector to inject a pre-determined amount of the chemical dispersant into a fluid contained in the recirculation path; and
(c) circulating the chemical dispersant in the recirculation path for a pre-determined amount of time to allow the chemical dispersant to mix with the fluid and suspend the corrosion products.
